(19) United States
(12) Patent Application Publication
(10) Pub. No.: US 2025/0201908 A1
(43) Pub. Date: Jun. 19, 2025

(54) SOLID ELECTROLYTE, SODIUM ALL-SOLID SECONDARY BATTERY INCLUDING THE SAME, AND ITS MANUFACTURING METHOD

(71) Applicant: Samsung Electronics Co., Ltd., Suwon-si (KR)

(72) Inventors: Hyunpyo Lee, Suwon-si (KR); Jonghoon Ka, Suwon-si (KR); Joungwon Park, Suwon-si (KR); Hyunjin Kim, Suwon-si (KR); Jungock Park, Suwon-si (KR); Youngsin Park, Suwon-si (KR)

(21) Appl. No.: 18/769,837

(22) Filed: Jul. 11, 2024

(30) Foreign Application Priority Data
Dec. 19, 2023 (KR) 10-2023-0186150

(51) Int. Cl. H01M 10/0562; C01G 41/00; H01M 4/131; H01M 4/133; H01M 4/58; H01M 4/587; H01M 10/054

(52) U.S. Cl. CPC H01M 10/0562; C01G 41/006; H01M 4/131; H01M 4/133; H01M 4/5825; H01M 4/587; H01M 10/054; C01P 2006/40; H01M 2300/008

(57) ABSTRACT

A sulfide solid electrolyte represented by Formula 1 and a sodium all-solid secondary battery including the same:

Na_{3±x}P_{1-(y1+y2)}W_{y1}M_{y2}S_{4-z}X_{z} Formula 1

wherein in Formula 1, M may be a trivalent element, a tetravalent element, or a combination thereof, X is a halogen atom, or a combination thereof, 0≤x≤1, 0<y1≤50.5, 0≤z≤1, and 0≤y2≤0.5, wherein if z=0, y2 is not 0.

### CROSS-REFERENCES TO RELATED APPLICATION

This application is based on and claims priority to Korean Patent Application No. 10-2023-0186150, filed on Dec. 19, 2023, in the Korean Intellectual Property Office, and all the benefits accruing therefrom under 35 U.S.C. § 119, the content of which is herein incorporated by reference in its entirety.

### BACKGROUND

### 1. Field

The disclosure relates to a solid electrolyte, a sodium all-solid secondary battery including the same, and its manufacturing method.

### 2. Description of the Related Art

In recent years, batteries providing increased energy density and safety have been under active development. Sodium batteries may be used in information devices, communication devices, vehicles, energy storage systems, and the like. For example, developments related to automobile safety have been emphasized as they directly affect human lives.

When a sodium battery includes a liquid electrolyte, generally the liquid electrolyte includes a flammable organic solvent. Such sodium batteries can have a high risk of overheating and fire in the event of a short-circuit.

In comparison to a liquid electrolyte, a solid electrolyte has a lower risk of overheating and fire in the event of a short-circuit. Sodium batteries containing a solid electrolyte may provide increased safety compared to sodium batteries with a liquid electrolyte.

Various challenges face the implementation of sodium batteries with solid electrolytes. During charging and discharging of a secondary battery, the interfacial resistance between the cathode and the solid electrolyte may increase. Due to increased interfacial resistance between the cathode and the solid electrolyte, overvoltage of the secondary battery may increase. Defects may form in the solid electrolyte layers during the manufacturing process and/or charge and discharge processes of the secondary battery, and from such defects, cracks in the solid electrolyte layer may form and develop.

Sodium dendrites may grow through such cracks, and lead to a short circuit. Furthermore, during charging and discharging of a secondary battery, sodium metal may form, and side reactions between the sodium metal and a solid electrolyte may increase. Such side reactions between the sodium metal and the solid electrolyte may increase overvoltage of the secondary battery or block dissolution of sodium metal, thus causing deterioration of a sodium all-solid secondary battery.

There is a need for a secondary battery that is capable of suppressing an increase in interfacial resistance and/or defect formation, during the manufacturing process and/or charging and discharging of the secondary battery and of effectively preventing side reactions between sodium metal and a solid electrolyte during charging and discharging of the secondary battery.

### SUMMARY

Provided is a solid electrolyte having improved ionic conductivity and stability.

Provided is a sodium all-solid secondary battery which, by utilizing the solid electrolyte, has decreased interfacial resistance between a cathode and a solid electrolyte layer and suppresses side reactions between an anode and a solid electrolyte layer, and thus has improved cycling performance.

Provided is a method of manufacturing a sodium all-solid secondary battery.

Additional aspects will be set forth in part in the description which follows and, in part, will be apparent from the description, or may be learned by practice of the presented embodiments of the present disclosure.

According to an aspect, a sulfide solid electrolyte is represented by Formula 1.

Na_{3±x}P_{1-(y1+y2)}W_{y1}M_{y2}S_{4-z}X_{z}, Formula 1
in Formula 1, M is a trivalent element, a tetravalent element, or a combination thereof,
X is a halogen atom or a combination thereof, O≤x≤1, 0<y1≤0.5, O≤z≤1, and O≤y2≤0.5, and if z=0, y2 is not 0.

According to another aspect, a sodium all-solid secondary battery includes: a cathode; an anode; and a solid electrolyte layer between the cathode and the anode. The cathode includes a cathode current collector and a cathode active material layer, and the anode includes an anode current collector and an anode active material layer. The cathode, the anode, the electrolyte layer, or a combination thereof may include the solid electrolyte.

According to an aspect, a method of preparing a sulfide solid electrolyte, the method includes combining a sodium precursor, a phosphorus precursor, a tungsten precursor, a M-containing precursor, a sulfur precursor, or a combination thereof to provide a precursor mixture; and treating the precursor mixture to provide the sulfide solid electrolyte. The sulfide solid electrolyte is represented by Formula 1:

Na_{3±x}P_{1-(y1+y2)}W_{y1}M_{y2}S_{4-z}X_{z}, Formula 1

in Formula 1, M is a trivalent element, a tetravalent element, or a combination thereof, X is a halogen atom, or a combination thereof, O≤x≤1, 0<y1≤0.5, O≤z≤1, O≤y2≤0.5, and if z=0, y2 is not 0.

According to an aspect, a method of manufacturing a sodium all-solid battery, the method includes providing a cathode, an anode, and a solid electrolyte layer between the cathode and the anode. The cathode, the anode, the solid electrolyte layer, or a combination thereof comprise a sulfide solid electrolyte represented by Formula 1, and the sulfide solid electrolyte is manufactured by combining a sodium precursor, a phosphorus precursor, a tungsten precursor, a M-containing precursor, and a sulfur precursor to provide a precursor mixture; and treating the precursor mixture to provide the sulfide solid electrolyte, wherein the sulfide solid electrolyte is represented by Formula 1:

Na_{3±x}P_{1-(y1+y2)}W_{y1}M_{y2}S_{4-z}X_{z}, Formula 1

in Formula 1, M is a trivalent element, a tetravalent element, or a combination thereof, X is a halogen atom, or a combination thereof, 0≤x≤1, 0<y1≤0.5, 0≤z≤1, O≤y2≤0.5, and if z=0, y2 is not 0.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a cross-sectional view illustrating an embodiment of a sodium all-solid secondary battery;

FIG. 2 is a cross-sectional view illustrating an embodiment of a sodium all-solid secondary battery;

FIG. 3 is a cross-sectional view illustrating an embodiment of a structure of a symmetric cell including a solid electrolyte; and

FIGS. 4A to 4D are graphs of imaginary impedance (ohms) versus real impedance (ohms) for a symmetric cell including solid electrolytes of Preparation Examples 1 to 3 and Comparative Preparation Example 2, respectively.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Various embodiments are shown in the accompanying drawings. These inventive concepts may, however, be embodied in many different forms and should not be construed as limited to the example embodiments set forth herein. Rather, these example embodiments are provided so that this disclosure will be thorough and complete, and will fully convey the scope of the inventive concepts to those skilled in the art. In the drawings, like numbers refer to like elements throughout.

It will also be understood that when an element is referred to as being “on” or “over” another element, it can be directly on the other element or intervening elements may also be present. In contrast, when an element is referred to as being “directly on” or “directly over” another element, there are no intervening elements present.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section, from another element, component, region, layer, or section. For example, a first element, component, region, layer, or section could be termed a second element, component, region, layer, or section, without departing from the teachings of the disclosure.

The terminology used herein is for the purpose of describing particular embodiments only and is not intended to be limiting of the present inventive concept. As used herein, the singular forms “a”, “an” and “the” are intended to include the plural forms as well including “at least one”, unless the context clearly indicates otherwise. The term “at least one” should not be interpreted as being limited to a singular form. As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, spatially relative terms, such as “lower”, “bottom”, or “below” and “upper”, “top”, or “above” may be used herein to conveniently describe one element or feature's relationship to another element or feature. It will be understood that spatially relative terms are intended to encompass different orientations of the device while the device is in use or operated, in addition to the orientation depicted in the drawings. For example, if the device in one of the figures is turned over, elements described as being on the “lower” or “bottom” side of other elements would then be oriented on “upper” or “top” sides of the other elements. Therefore, exemplary term “lower” can therefore, encompasses both an orientation of “lower” and “upper”. The device may be placed in other orientations (may be rotated by 90 degrees or in a different direction), and spatially relative terms used herein may be interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the specification and the relevant art and should not be interpreted in an idealized sense or an overly formal sense unless expressly so defined herein.

Embodiments are described herein with reference to cross section illustrations that are schematic illustrations of idealized embodiments. As such, variations from the illustrated shapes as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, angles that are illustrated as being sharp may be rounded. Thus, the regions illustrated in the figures are schematic in nature and their shapes are not intended to illustrate the precise shape of a region and are not intended to limit the scope of the present claims.

“Group” refers to a group in the Periodic Table of Elements of the Elements according to the 1-18 Group numbering system by the International Union of Pure and Applied Chemistry (“IUPAC”).

The term “particle diameter” or “particle size” as used herein refers to an average particle diameter when the particle is spherical, and refers to an average major axis length when the particle is non-spherical. The particle diameter or “particle size” may be measured using a particle size analyzer (PSA). The average major axis length may be measured by using scanning electron microscope (SEM). The term “particle diameter” or “particle size” as used herein refers to, for example, an average particle diameter. The term “average particle diameter” as used herein may refer to, for example, a median particle diameter (D50).

D50 may refer to a particle size corresponding to a cumulative 50 volume percent (vol %) as calculated from the side of particles with the smallest particle size in a particle size distribution as measured by a laser diffraction method.

D90 may refer to a particle size corresponding to a cumulative 90 vol % as calculated from the side of particles with the smallest particle size in a particle size distribution as measured by a laser diffraction method.

D10 may refer to a particle size corresponding to a cumulative 10 vol % as calculated from the side of particles with the smallest particle size in a particle size distribution as measured by a laser diffraction method.

The term “metal” as used herein refers to both metals and metalloids such as silicon and germanium, in an elemental or ionic state.

The term “thickness” as used herein refers to an average thickness.

As used herein, the term “electrode active material” refers to an electrode material capable of undergoing sodiation and desodiation.

The term “cathode active material” as used herein refers to a cathode material capable of undergoing sodiation and desodiation.

The term “anode active material” as used herein refers to an anode material capable of undergoing sodiation and desodiation.

The terms “sodiation” and “to sodiate” as used herein refer to a process of adding sodium to an electrode active material.

The terms “desodiation” and “to desodiate” as used herein refer to a process of removing sodium from an electrode active material.

As used herein, the terms “charging” and “to charge” refer to a process of providing electrochemical energy to a battery.

As used herein, the terms “discharging” and “to discharge” refer to a process of removing electrochemical energy from a battery.

As used herein, the terms “positive electrode” and “cathode” refer to an electrode at which electrochemical reduction and sodiation take place during a discharge process.

As used herein, the terms “negative electrode” and “anode” refer to an electrode at which electrochemical oxidation and desodiation take place during a discharge process.

While specific examples and are described herein, there may be alternatives, modifications, variations, improvements, and substantial equivalents of the examples disclosed herein, including those that are not presently unforeseen or unappreciated, may arise from applicants or those skilled in the art. Accordingly, the appended claims as filed and as they can be amended are intended to embrace all such alternatives, modifications, variations, improvements and substantial equivalents.

Hereinafter, a solid electrolyte, a method of preparing the same, and a sodium all-solid secondary battery according to embodiments will be described in greater detail.

A solid electrolyte of Na₃PS₄ shows an ionic conductivity of about 10-⁵ siemens per centimeter (S/cm) and is not easy to charge and discharge at a common charge-discharge current density due to high overvoltage. Furthermore, when in contact with sodium metal, decomposition products with low ionic conductivity are generated at the solid electrolyte-sodium metal interface, which may deteriorate the lifespan characteristics of a sodium solid secondary battery.

To address the aforementioned issues of overvoltage and decomposition products, provided is a solid electrolyte which has increased ionic conductivity and improved stability with respect to sodium metal by substituting part of P of the solid electrolyte of Na₃PS₄ with W and one or more elements of trivalent elements or tetravalent elements, and has improved stability by substituting part of S with a halogen atom in the solid electrolyte of Na₃PS₄.

A solid electrolyte according to an embodiment may be a sulfide-based solid electrolyte represented by Formula 1.

Na_{3±x}P_{1-(y1+y2)}W_{y1}M_{y2}S_{4-z}X_{z} Formula 1

In Formula 1, M may be a trivalent element, a tetravalent element, or a combination thereof, X may be a halogen atom or a combination thereof, 0≤x≤1, 0<y1≤0.5, 0≤z≤1, 0≤y2≤0.5, and wherein z=0, y2 is not 0.

In the solid electrolyte, as shown in Formula 1, part of phosphorus may be substituted with tungsten or with tungsten and M. In addition, part of sulfur may be substituted with a halogen atom X, so that the solid electrolyte may have improved stability with sodium metal and increased ionic conductivity.

M may be Sn, Si, Al, Ga, Ge, or a combination thereof. These elements show low reactivity with sodium metal. X may be a halogen atom such as F, Cl, Br, I, or a combination thereof.

The solid electrolyte may have a sodium ion-conductivity at room temperature (25° C.) of 0.05 millisiemens per centimeter (mS/cm) or more, or about 1 mS/cm to about 10 mS/cm. With the solid electrolyte having an ionic conductivity within the aforementioned ranges, an all-solid secondary battery having excellent cycling performance may be prepared.

In Formula 1, y2 may be 0, or 0.1≤y1≤0.3, or 0.1≤y1≤0.2.

In Formula 1, 0.01≤z≤0.5.

In Formula 1, 0.012≤z≤0.5, 0.015≤z≤0.5, 0.02≤z≤0.5, 0.05≤z≤0.3, 0.05≤z≤0.2, or 0.05≤z≤0.1.

The solid electrolyte according to an embodiment may be a solid electrolyte represented by Formulas 2 to 4, or a combination thereof.

Na_{3±x}P_{1-(y1+y2)}W_{y1}Sn_{y2}S_{4-z}X_{z} Formula 2

In Formula 2, X may be a halogen atom, 0≤x≤1, 0<y1 0.5, 0≤z≤1, 0≤y2≤0.5, and if z=0, y2 is not 0.

Na_{3±x}P_{1-(y1+y2)}W_{y1}Al_{y2}S_{4-z}X_{z} Formula 3

In Formula 3, X may be a halogen atom, 0≤x≤1, 0<y1 0.5, 0≤z≤1, 0≤y2≤0.5, and if z=0, y2 is not 0.

Na_{3±x}P_{1-(y1+y2)}W_{y1}Sn_{y2}S_{4-z}X_{z} Formula 4

In Formula 4, X may be a halogen atom, 0≤x≤1, 0<y1 0.5, 0≤z≤1, 0≤y2≤0.5, and if z=0, y2 is not 0.

In Formulas 2 to 4, X may be a halogen atom such as F, Cl, Br, I, or a combination thereof.

The solid electrolyte may be, for example, Na₃P_{0.8}W_{0.1}Si_{0.1}S₄, Na_{3.1}P_{0.8}W_{0.1}Al_{0.1}S₄, Na₃P_{0.8}W_{0.1}Sn_{0.1}S₄, Na_{2.9}P_{0.8}W_{0.1}Si_{0.1}S_{3.9}Cl_{0.1}, Na₃P_{0.8}W_{0.1}Al_{0.1}S_{3.9}Cl_{0.1}, Na_{2.8}P_{0.9}W_{0.1}S_{3.9}Cl_{0.1}, Na_{2.8}P_{0.8}W_{0.2}S_{3.9}Cl_{0.1}, Na_{2.8}P_{0.7}W_{0.3}S_{3.9}Cl_{0.1}, Na_{2.8}P_{0.7}W_{0.3}S_{3.9}Cl_{0.1}, Na₃P_{0.8}W_{0.1}Sn_{0.1}S_{3.9}Cl_{0.1}, Na₃P_{0.8}W_{0.1}Si_{0.05}Sn_{0.05}S₄, Na_{2.9}P_{0.8}W_{0.1}Si_{0.1}S_{3.9}CO_{0.05}Br_{0.05}, Na₃P_{0.8}W_{0.1}Al_{0.1}S_{3.9}Cl_{0.05}Br_{0.05}, Na_{2.8}P_{0.9}W_{0.1}S_{3.9}Cl_{0.05}Br_{0.05}, Na₃P_{0.8}W_{0.1}Ge_{0.1}S₄, Na_{2.9}P_{0.8}W_{0.1}Ge_{0.1}S_{3.9}Cl_{0.1}, Na_{3.1}P_{0.8}W_{0.1}Ga_{0.1}S₄, Na₃P_{0.8}W_{0.1}Ga_{0.1}S_{3.9}Cl_{0.1} Na₃P_{0.8}W_{0.15}Si_{0.05}S₄, Na_{3.1}P_{0.8}W_{0.15}Al_{0.05}S₄, Na₃P_{0.8}W_{0.15}Sn_{0.05}S₄, Na_{2.9}P_{0.8}W_{0.15}Si_{0.05}S₃.Cl_{0.1}, Na_{2.9}P_{0.8}W_{0.15}Si_{0.05}S_{3.9}Cl_{0.05}Br_{0.05}, Na₃P_{0.8}W_{0.15}Al_{0.05}S_{3.9}Cl_{0.1}, Na₃P_{0.8}W_{0.15}Al_{0.05}S_{3.9}Cl_{0.05}Br_{0.05}, Na₃P_{0.7}W_{0.15}Si_{0.15}S₄, Na_{3.1}P_{0.7}W_{0.15}Al_{0.15}S₄, Na₃P_{0.7}W_{0.15}Sn_{0.15}S₄, Na_{2.9}P_{0.7}W_{0.15}Si_{0.15}S_{3.9}Cl_{0.1}, Na₃P_{0.7}W_{0.15}Al_{0.15}S_{3.9}Cl_{0.1}, or a combination thereof.

The solid electrolyte may have a glass-ceramics phase. Additionally, a glass phase means a substantially amorphous state. Here, “substantially” includes cases where the solid electrolyte in a crystalline state is finely dispersed in addition to 100% amorphous state. The glass-ceramics phase refers to a state created by heating a glass-phase solid electrolyte to a glass transition temperature or greater. A solid electrolyte in a glass-ceramics phase may also refer to a solid electrolyte in a state in which at least a crystalline portion is dispersed in a glass component in an amorphous state. The proportion of the crystalline portion may be, for example, 0.001%, 0.01%, 0.1%, 1%, 3%, 5%, 10%, 15%, 20%, 25%, 30%, 35%, 40%, 45%, 50%, 55%, 60%, 65%, 70%, 75%, 80%, 85%, 90%, 95%, 97%, 99%, 99.9%, 100%, and so on. The proportion of the crystalline portion may be 50 weight percent (wt %) or more, 80 wt % or more, 90 wt % or more, 95 wt % or more, or 99 wt % or more, with respect to the total weight of the glass-ceramics. According to another embodiment, the proportion of the crystalline portion may be 100 wt %. In addition, the proportion of the crystalline portion may be measured by nuclear magnetic resonance (NMR) spectroscopy. The crystalline portion may be in a cubic phase and/or tetragonal phase. For example, the crystalline portion may consist of a cubic phase. Additionally, the solid electrolyte in the glass-ceramics phase may not have a glass transition temperature at the former glass transition temperature for the corresponding glass-phase solid electrolyte.

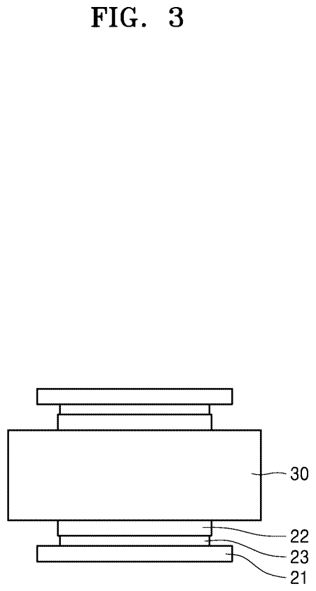

The interfacial resistance of a symmetric cell containing the solid electrolyte and a sodium electrode may be about 10 ohms (0) to about 2,000 0. The symmetric cell may have a stacked structure as shown in FIG. 3.

The symmetric cell may have a structure in which an anode active material layer 22, a sodium anode 23, and a current collector 21 are sequentially stacked on both sides of the solid electrolyte layer 30.

A method of preparing a solid electrolyte according to an embodiment may be as follows.

First, a precursor mixture may be prepared to obtain a solid electrolyte of Formula 1 below.

Na_{3±x}P_{1-(y1+y2)}W_{y1}M_{y2}S_{4-z}X_{z} Formula 1

In Formula 1, M may be a trivalent element, a tetravalent element, or a combination thereof, 0≤x≤1, 0<y1<0.5, 0≤z≤1, 0≤y2≤0.5, and if z=0, y2 is not 0, and X may be a halogen atom. X may be a halogen atom such as F, Cl, Br, I, or a combination thereof.

The precursor mixture may include a sodium precursor, a phosphorus precursor, a tungsten precursor, an M-containing precursor, a sulfur precursor, or a combination thereof.

Examples of the sodium precursor include Na₂S and the like; examples of the phosphorus precursor include P₂S₅ and the like; and examples of the tungsten precursor include WS₂ and the like. Examples of the M-containing precursor include SiS₂, a tin sulfide, and the like. Examples of the sulfur precursor can include sulfur.

A precursor mixture may be prepared by combining the sodium precursor, the phosphorus precursor, the tungsten precursor, the M-containing precursor, the sulfur precursor, or a combination thereof, in a stoichiometric amount so as to obtain a target solid electrolyte, and then treating the precursor mixture to provide the sulfide solid electrolyte. The treating of the precursor mixture can include mixing, heat treating, balling milling, and so forth. In an embodiment the precursor mixture may be mechanically milled. The mechanical milling may be performed, for example, by planetary ball milling, a ball mill, an air-jet mill, a bead mill, a roll mill, or the like, to provide a solid electrolyte powder.

The milling conditions may include a rotation rate of about 50 revolutions per minute (rpm) to about 600 rpm, a treatment time of 0.1 hour to 100 hours, and about 1 kilowatt-hours per kilogram (kWh/kg) to about 100 kWh/kg of material.

A rest period may be included after milling. A milling/rest cycle may be performed repeatedly.

The solid electrolyte powder may be subjected to a heat treatment at about 450° C. to about 750° C., about 500° C. to about 650° C., or about 520° C. to about 570° C. The heat-treatment time may be about 1 minute to about 24 hours. For example, the heat-treatment time may be about 3 minutes to about 24 hours, or about 5 minutes to about 10 hours.

### Sodium All-Solid Secondary Battery

A sodium all-solid secondary battery according to an embodiment may include a cathode; an anode; a solid electrolyte layer between the cathode and the anode, wherein the cathode may include a cathode current collector and a cathode active material layer, the anode may include an anode current collector and an anode active material layer, and the cathode, the anode, the solid electrolyte layer, or a combination thereof may include a solid electrolyte according to an embodiment.

The solid electrolyte may be included in a cathode active material layer of a cathode. In addition, the solid electrolyte may be contained in the anode active material layer.

Because a solid electrolyte layer according to an embodiment is disposed between the cathode and the anode, an increase of interfacial resistance between the cathode and the electrolyte may be effectively suppressed during charging and discharging of a sodium all-solid secondary battery. An increase of overvoltage that occurs during the charging and discharging of a sodium all-solid secondary battery may be effectively suppressed.

Because a solid electrolyte layer according to an embodiment is disposed between the cathode and the anode, defect formation within the electrolyte may be effectively suppressed during the manufacture process and/or the charging and discharging of a sodium all-solid secondary battery. It may be possible to prevent a short circuit and/or deterioration of lifespan characteristics of a sodium all-solid secondary battery due to growth of such defects. The cycling performance of a sodium all-solid secondary battery may improve.

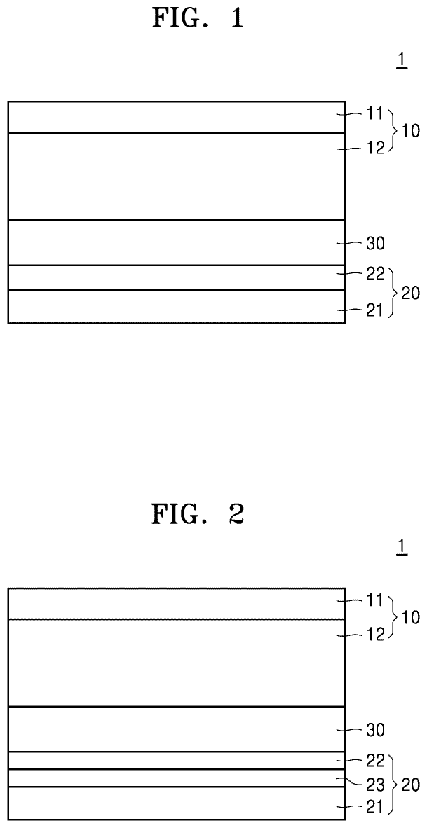

Referring to FIGS. 1 and 2, a sodium all-solid secondary battery 1 may include a cathode 10; an anode 20; and a solid electrolyte layer 30 between the cathode 10 and the anode 20. A sulfide solid electrolyte 31 may be disposed between the cathode 10 and the anode 20.

The cathode 10 may include a cathode current collector 11 and a cathode active material layer 12. The anode 20 may include an anode current collector 21 and an anode active material layer 22.

### Solid Electrolyte Layer

A solid electrolyte layer may include a solid electrolyte. The solid electrolyte may further include, other than the solid electrolyte according to an embodiment, a sulfide solid electrolyte, an oxide solid electrolyte, or a combination thereof.

For example, the sulfide solid electrolyte may include an argyrodite-type solid electrolyte represented by Formula 13:

Na⁺₁₂₋ₙ₋ₓAⁿ⁺X²⁻₆₋ₓY⁻ₓ Formula 13

In Formula 13, A may be P, As, Ge, Ga, Sb, Si, Sn, Al, In, Ti, V, Nb, or Ta, X may be S, Se, or Te, Y may be Cl, Br, I, F, CN, OCN, SCN, or N₃, and 1≤n≤5, 0≤x≤2. The sulfide solid electrolyte may be, for example, an argyrodite-type compound including one or more of Na₇₋ₓPS₆₋ₓClₓ wherein O≤x≤2, Na₇₋ₓPS₆₋ₓBrₓ wherein 0≤x≤2, or Na₇₋ₓPS₆₋ₓlₓ wherein 0≤x≤2. For example, the sulfide solid electrolyte may be an argyrodite-type compound including at least one of Na₆PS₅Cl, Na₆PS₅Br, or Na₆PS₅I.

An argyrodite-type solid electrolyte may have a density of about 1.5 grams per cubic centimeter (g/cc) to about 2.0 g/cc. With the argyrodite-type solid electrolyte having a density of 1.5 g/cc or more, the internal resistance of a sodium all-solid secondary battery 1 may be reduced, and Na penetration to the solid electrolyte layer may be more effectively suppressed.

The sulfide solid electrolyte may have a crystalline state, an amorphous state, a glassy state, or a glass-ceramics state. The sulfide solid electrolyte may have, for example, a sodium-ion conductivity at 25° C., 1 atm of 1×10⁻⁵ S/cm or more, 1×10⁻⁴ S/cm or more, or 1×10⁻³ S/cm or more. Sodium-ion conductivity may be determined, for example, by impedance measurement.

The solid electrolyte may further include a sulfide solid electrolyte, an oxide solid electrolyte, a polymer solid electrolyte, or a combination thereof, and the gel electrolyte may include a polymer gel electrolyte.

The sulfide solid electrolyte may include, for example, Na₃PS₄, Na₃₋ₓPS₄₋ₓClₓ (wherein 0<x<3), Na₃₋ₓP₁₋ₓWₓS₄ (wherein 0≤x<1), Na₃PS₄₋ₓOₓ (wherein 0<x<4), Na₃₋₂ₓCaₓPS₄ (wherein 0<x<1.5), Na₃SbS₄, Na₃₋ₓSb₁₋ₓWₓS₄ (wherein 0≤x<1), Na_{2.88}Sb_{0.88}W_{0.12}S₄₋ₓNal (wherein 0<x<1), Na₃WₓSiₓSb₁₋₂ₓS₄ (wherein 0≤x<0.5), Na₃₋ₓSb₁₋ₓWₓS₄₋₃ₓO₃ₓ (wherein 0≤x<1), Na₃SbS₄—Na₂WₓS₄I₆ₓ₋₄ (wherein 0≤x<1), Na₂S—P₂S₅, Na₂S—P₂S₅—NaX (wherein X is F, C, Br, or I), Na₂S—P₂S₅—Na₂O, Na₂S—P₂S₅—Na₂O-Nal, Na₂S—SiS₂, Na₂S—SiS₂-Nal, Na₂S—SiS₂—NaBr, Na₂S—SiS₂—NaCl, Na₂S—SiS₂—B₂S₃-Nal, Na₂S—SiS₂—P₂S₅-Nal, Na₂S—B₂S₃, Na₂S—P₂S₅—ZₘSₙ, (wherein 0<m≤10, 0<n≤10, and Z is Ge, Zn, or Ga), Na₂S—GeS₂, Na₂S—SiS₂—Na₃PO₄, Na₂S—SiS₂-NaₚMO_{q} (wherein 0<p≤10, 0<q≤10, and M is P, Si, Ge, B, Al, Ga, or In), Na₇₋ₓPS₆₋ₓClₓ (wherein 0≤x≤2), Na₇₋ₓPS₆₋ₓBrₓ (wherein 0≤x≤2), Na₇₋ₓPS₆₋ₓlₓ (wherein 0≤x≤2), Na₁₀MP₂S₁₂ (wherein M is Ge, Si, or Sₙ), or a combination thereof. The sulfide solid electrolyte may have a crystalline state, an amorphous state, a glassy state, or a glass-ceramics state.

The oxide solid electrolyte may include, for example, NaₐM1_{b}M2_{c}O_{d}, (wherein M1 is Al, Y, Yb, Nd, Nb, Ti, or Hf, M2 is Si or P, 1≤a≤6 1≤b≤3, 2≤c≤5, and 5≤d≤15), Na₁₊ₓZr₂SiₓP₃₋ₓO₁₂ (wherein 0≤x≤3), NaₓM₂(PO₄)₃ (wherein M is V or Ti, and 0≤x≤3), Na₃₊ₓLa_{(2/3-x)(1/3-2x)}TiO₃ (wherein 0.04<x<0.16), Na₁₊ₓAlₓTi₂₋ₓ(PO₄)₃ (wherein 0<x<2), Na₁₊ₓAlₓGe₂₋ₓ(PO₄)₃ (wherein 0<x<2), Na_{1+x+y}AlₓTi₂₋ₓSi_{y}P_{3-y}O₁₂ (wherein 0<x<2 and 0≤y<3), BaTiO₃, Pb(ZrₐTi₁₋ₐ)O₃ (wherein 0≤a≤1), Pb₁₋ₓLaₓZr_{1-y}Ti_{y}O₃ (wherein 0≤x<1 and 0≤y<1), Pb(Mg_{1/3}Nb_{2/3})O₃—P_{b}TiO₃, Na₃PO₄, NaₓTi_{y}(PO₄)₃ (wherein 0<x<2 and 0<y<3), NaₓAl_{y}Ti_{z}(PO₄)₃ (wherein 0<x<2, 0<y<1, and 0<z<3), Na_{1+x+y}(AlₐGa₁₋ₐ)ₓ(Ti_{b}Ge_{1-b})₂₋ₓSi_{y}P_{3-y}O₁₂ (wherein 0≤x≤1, 0≤y≤1, 0≤a≤1, and 0≤b≤1), NaₓLa_{y}TiO₃ (wherein 0<x<2 and 0<y<3), Na₂O, NaOH, Na₂CO₃, NaAlO₂, Na₂O—Al₂O₃—SiO₂—P₂O₅—TiO₂—GeO₂, Na₃₊ₓLa₃M₂O₁₂ (wherein M is Te, Nb or Zr and 1≤x≤10), Na₇La₃Zr₂O₁₂, Na₃₊ₓLa₃Zr₂₋ₐMₐO₁₂ (wherein M is Ga, W, Nb, Ta, or Al, 0<a<2, and 1≤x≤10), or a combination thereof. However, the oxide solid electrolyte is not limited to the aforementioned examples, but may utilize any oxide solid electrolyte available in the art. The oxide solid electrolyte may be, for example, NASICON solid electrolyte expressed as Na₁₊ₓZr₂SiₓP₃₋ₓO₁₂ (wherein 0≤x≤3).

The oxide solid electrolyte may have a crystalline state, an amorphous state, a glassy state, or a glass-ceramics state. The oxide solid electrolyte may have, for example, a sodium-ion conductivity at 25° C., 1 atm of 1×10⁻⁵ S/cm or more, 1×10⁻⁴ S/cm or more, or 1×10⁻³ S/cm or more. Sodium-ion conductivity may be determined, for example, by impedance measurement.

For example, the polymer solid electrolyte may include a mixture of a sodium salt and a polymer or may include a polymer having an ion-conducting functional group. For example, the polymer solid electrolyte may be a polymer electrolyte that is in a solid state at 25° C. and 1 atmosphere (atm). For example, the polymer solid electrolyte may not contain liquid. The polymer solid electrolyte may include a polymer. For example, the polymer may be polyethylene oxide (PEO), polyvinylidene fluoride (PVDF), vinylidene fluoride-hexafluoropropylene (PVDF-HFP), a poly(styrene-b-ethylene oxide) block copolymer (PS-PEO), poly(styrene-butadiene), poly(styrene-isoprene-styrene), a poly(styrene-b-divinylbenzene) block copolymer, a poly(styrene-ethylene oxide-styrene) block copolymer, polystyrene sulfonate (PSS), polyvinyl fluoride (PVF), poly(methyl methacrylate) (PMMA), polyethylene glycol (PEG), polyacrylonitrile (PAN), polytetrafluoroethylene (PTFE), polyethylenedioxythiophene (PEDOT), polypyrrole (PPY), polyacrylonitrile (PAN), polyaniline, polyacetylene, Nafion, Aquivion, Flemion, Gore, Aciplex, Morgane ADP, sulfonated poly(ether ether ketone) (SPEEK), sulfonated poly(arylene ether ketone ketone sulfone (SPAEKKS), sulfonated poly(aryl ether ketone (SPAEK), poly[bis(benzimidazobenzisoquinolinones)](SPBIBI), poly(styrene sulfonate) (PSS), sodium 9,10-diphenylanthracene-2-sulfonate (DPASNa+), or a combination thereof. However, the polymer is not limited to the aforementioned examples and may be any material available in the art that is used in polymer electrolyte. The sodium salt may be any sodium salt available in the art. The sodium salt may be, for example, NaClO₄, NaPF₆, NaBF₄, NaSbF₆, NaAsF₆, NaCF₃SO₃, Na(CF₃SO₂)₂N, NaC₄F₉SO₃, NaAlO₂, NaAICl₄, NaN(CₓF₂ₓ₊₁SO₂)(C_{y}F_{2y+1}SO₂) (wherein x and y are each 1 to 20), NaCl, Nal, NaTFSI (TFSI=bis(trifluoromethane)sulfonimide), NaFSI (FSI=bis(fluorosulfonyl)imide), NaDFOB (DFOB=difluoro(oxalato)borate), NaBOB (bis(oxalato)borate), or a mixture thereof. For example, the polymer included in the polymer solid electrolyte may be a compound containing 10 or more repeating units, 20 or more repeating units, 50 or more repeating units, or 100 or more repeating units. For example, the polymer included in the polymer solid electrolyte may have a weight average molecular weight of 1,000 Dalton or more, 10,000 Dalton or more, 100,000 Dalton or more, or 1,000,000 Dalton or more.

The polymer solid electrolyte may act as an electrolyte as well as a binder to bind a sulfide electrolyte 31 and an oxide electrolyte 32 together.

The gel electrolyte may be, for example, a polymer gel electrolyte. For example, the gel electrolyte may have a gel state while not containing a polymer.

For example, the polymer gel electrolyte may include a liquid electrolyte and a polymer, or may include an organic solvent and a polymer having an ion-conducting functional group. The polymer gel electrolyte may be, for example, a polymer electrolyte that is in a gel state at 25° C. and 1 atm. For example, the polymer gel electrolyte may have a gel state without containing liquid. The liquid electrolytes used in the polymer gel electrolytes may be, for example, a mixture of an ionic liquid, a sodium salt, and an organic solvent; a mixture of a sodium salt and an organic solvent; a mixture of an ionic liquid and an organic solvent; or a mixture of a sodium salt, an ionic liquid, and an organic solvent. The sodium salt may be selected from the sodium salts described above. The polymer used in the polymer gel electrolyte may be selected from the polymers used in the polymer solid electrolyte. The organic solvent may be selected from the organic solvents used in the liquid electrolyte. The organic solvent may be, for example, propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethyl sulfoxide, dioxane, 1,2-dimethoxyethane, sulfolane, dichloroethane, chlorobenzene, nitrobenzene, diethylene glycol, dimethyl ether, and a mixture thereof. The sodium salt may be selected from the sodium salts used in the polymer solid electrolyte. The ionic liquid may refer to a room-temperature molten salt or a salt that is in a liquid state at room temperature, which consists of ions alone and has a melting point of room temperature or less. For example, the ionic liquid may be of compounds containing: a) at least one cation of ammonium, pyrrolidinium, pyridinium, pyrimidinium, imidazolium, piperidinium, pyrazolium, oxazolium, pyridazinium, phosphonium, sulfonium, triazolium, or a mixture thereof; or b) at least one anion of BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, (CF₃SO₂)₂N⁻, or combination. For example, the polymer solid electrolyte may form a polymer gel electrolyte by impregnation in a liquid electrolyte in a secondary battery. The polymer gel electrolyte may further include inorganic particles. For example, the polymer included in the polymer gel electrolyte may be a compound containing 10 or more repeating units, 20 or more repeating units, 50 or more repeating units, or 100 or more repeating units. For example, the polymer included in the polymer gel electrolyte may have a weight average molecular weight of 500 Dalton or more, 1,000 Dalton or more, 10,000 Dalton or more, 100,000 Dalton or more, or 1,000,000 Dalton or more.

The polymer gel electrolyte may act as an electrolyte as well as a binder. The polymer gel electrolyte may have, for example, a configuration where a porous polymer substrate is impregnated with a liquid electrolyte. The porous polymer substrate may be, for example, a porous separator. Any porous separator usable in conventional secondary batteries may be utilized. The porous separator may act as a binder.

The solid electrolyte layer 30 according to an embodiment may contain a sulfide electrolyte according to an embodiment. Including such a sulfide solid electrolyte may allow for maintaining a low interfacial resistance with the cathode 10.

The cathode 10 may contain a solid electrolyte. The solid electrolyte may contain a sulfide solid electrolyte. The cathode 10 may contain the same or a similar sulfide solid electrolyte as the solid electrolyte layer 30. Because the sulfide solid electrolyte shows ductility, defect formation, such as voids, may be suppressed between the cathode 10 and the solid electrolyte layer 30. The solid electrolyte layer 30 including the sulfide electrolyte may more effectively accommodate volume changes of the cathode 10 and/or the anode 20 that occur during charging and discharging of the all-solid secondary battery 1. Because the solid electrolyte layer 30 adjacent to the cathode 10 includes a sulfide solid electrolyte, the cycling performance of the all-solid secondary battery 1 may improve.

The thickness of the solid electrolyte layer 30 may be, for example, about 1 micrometer (μm) to about 1,000 μm, about 1 μm to about 500 μm, about 1 μm to about 100 μm, about 1 μm to about 50 μm, about 1 μm to about 30 μm, or about 1 μm to about 10 μm. By having a thickness in the aforementioned ranges, the solid electrolyte layer 30 may maintain a low interfacial resistance with the cathode 10 while effectively accommodating volume changes during charging and discharging of the all-solid secondary battery 1. If the thickness of the solid electrolyte layer 30 is excessively small, the solid electrolyte 30 may be unable to provide sufficient ionic conductivity during high-rate charging and discharging. If the thickness of the solid electrolyte layer (30) excessively increases, the energy density of the all-solid secondary battery 1 may decrease.

### Solid Electrolyte Layer: Sulfide Electrolyte: Binder

The solid electrolyte layer 30 may further include, for example, a binder. The binder in the solid electrolyte layer 30 may be identical to or different from the binders included in the cathode 10 and the anode 20. The binder may be omitted.

The binder may be, for example, styrene butadiene rubber (SBR), polytetrafluoroethylene, polyvinylidene fluoride, polyethylene, and the like, but without being limited to the aforementioned examples, may utilize any material used as a binder in the art. The amount of the binder may be, for example, about 0.1 wt % to about 10 wt %, about 0.1 wt % to about 5 wt %, about 0.1 wt % to about 3 wt %, or about 0.1 wt % to about 1 wt %, with respect to the total weight of the electrolyte.

### Cathode

### Cathode: Cathode Active Material

Referring to FIGS. 1 to 2, a cathode active material layer 12 may include, for example, a cathode active material.

The cathode active material may be a sodium transition metal oxide, a polyanionic compound, or a Prussian blue-type compound.

The transition metal of the sodium transition metal oxide may include, for example, Mn, Fe, Ni, Co, Cr, Cu, Ti, Zn, V, Zr, Ce, or a combination thereof. Examples of the sodium transition metal oxide include compounds containing sodium, a transition metal, and an oxygen unit. The sodium content of the sodium transition metal oxide may be greater than 0 and less than or equal to 1, the transition metal content may be 1, the transition metal M may include Ti, V, Mn, Co, Ni, Fe, Cr, Cu or a combination thereof, and the oxygen (O₂) content may be 1.

Examples of the polyanionic compound include compounds containing sodium or a transition metal and a tetrahedral (YO₄)ⁿ⁻ anion unit. The transition metal may include, for example, Mn, Fe, Ni, Co, Cr, Cu, Ti, Zn, V, Zr, Ce, or a combination thereof. Y may include, for example, P, S, Si or a combination thereof. The n represents the valence state of (YO₄)ⁿ⁻ and may be, for example, 1 to 5.

Examples of the polyanionic compound include compounds including sodium, a transition metal, a tetrahedral (YO₄)ⁿ⁻ anion unit, and a halogen. The transition metal may include, for example, Mn, Fe, Ni, Co, Cr, Cu, Ti, Zn, V, Zr, Ce, or a combination thereof.

Y may include, for example, P, S, Si or a combination thereof. The n represents the valence state of (YO₄)ⁿ⁻ and may be, for example, 1 to 5. The halogen may include, for example, F, Cl, Br, I, or a combination thereof.

The polyanionic compound may be, for example, a compound including sodium, a tetrahedral (YO₄)ⁿ⁻ anion unit, a polyhedral (ZO_{y})^{m+} unit, and optionally a halogen. Y may include, for example, P, S, Si or a combination thereof. The n represents the valence state of (YO₄)ⁿ⁻ and may be, for example, 1 to 5. Z may be, for example, a transition metal including Mn, Fe, Ni, Co, Cr, Cu, Ti, Zn, V, Zr, Ce, or a combination thereof. The m represents the valence state of (ZO_{y})^{m+} and may be, for example, 1 to 5. The halogen may include, for example, F, Cl, Br, I, or a combination thereof.

Examples of the polyanionic compound include NaFePO₄, Na₃V₂(PO₄)₃, NaM′PO₄F (wherein M′ is V, Fe, Mn, Ni or a combination thereof), Na₃(VO_{y})₂(PO₄)₂F_{3-2y} (wherein 0≤y≤1), or a combination thereof.

The Prussian blue-type compound may be, for example, a compound having sodium, a transition metal, and a cyanide unit (CN—). The transition metal may include, for example, Mn, Fe, Ni, Co, Cr, Cu, Ti, Zn, V, Zr, Ce, or a combination thereof.

The Prussian blue-type compound may be, for example, a compound including sodium, a first transition metal, a second transition metal, and a cyanide unit. The sodium content of the Prussian blue-type compound may be greater than 0 and less than 2, the amount of the first transition metal and second transition metal may be greater than 0 and less than 1, respectively, the first and second transition metals may each independently be Ni, Cu, Fe, Mn, Co, Zn, or a combination thereof, and the amount of the cyanide unit may be 6.

A compound having a coating layer added on a surface of the above compound may also be used. Furthermore, a mixture of the above compound with a compound having a coating layer added thereon may also be used. The coating layer added on the surface of the aforementioned compound may include, for example, compounds of a coating element, such as oxides and hydroxides of the coating element, oxyhydroxides of the coating element, oxycarbonates of the coating element, and hydroxycarbonates of the coating element. A compound forming this coating layer may have an amorphous or crystalline state. The coating element included in the coating layer may be Mg, Al, Co, K, Na, Ca, Si, Ti, V, Sn, Ge, Ga, B, As, Zr, or a mixture thereof. The method of forming the coating layer may be selected within a range that does not adversely affect the physical properties of a cathode active material. Examples of a coating method include spray coating, dip coating, and the like. Specific coating methods are well known to those of ordinary skill in the art and therefore, detailed descriptions thereof will be omitted here.

The cathode active material may be, for example, one or more one or more polyanionic compounds selected from Formulas 5 to 9, layered sodium transition metal oxides represented by Formulas 10 and 11, a Prussian blue-type compound represented by Formula 12, or a combination thereof:

NaM(XO₄) Formula 5

In Formula 5, M may be manganese (Mn), iron (Fe), nickel (Ni), cobalt (Co), chromium (Cr), copper (Cu), titanium (Ti), zinc (Zn), vanadium (V), zirconium (Zr)), cerium (Ce), or a combination thereof, and

X may be phosphorus (P), sulfur (S), silicon (Si), or a combination thereof.

NaₓM_{y}(XO₄)₃ Formula 6

In Formula 6, 0<x≤3 and 0<y≤2, M may be manganese (Mn), iron (Fe), nickel (Ni), cobalt (Co), chromium (Cr), copper (Cu), titanium (Ti), zinc (Zn), vanadium (V), zirconium (Zr), cerium (Ce), or a combination thereof, and X may be phosphorus (P), sulfur (S), silicon (Si), or a combination thereof.

NaₓM_{y}(XO₄)Z_{z} Formula 7

In Formula 7, 0<x≤3, 0<y≤2, and 0<z≤1, M may be manganese (Mn), iron (Fe), nickel (Ni), cobalt (Co), chromium (Cr), copper (Cu), titanium (Ti), zinc (Zn), vanadium (V), zirconium (Zr)), cerium (Ce), or a combination thereof, X may be phosphorus (P), sulfur (S), silicon (Si), or a combination thereof, and Z may be F, Cl, Br, I, or a combination thereof.

Naₓ(MOₐ)_{y}(XO₄)_{z}Zᵥ Formula 8

In Formula 8, 0<x≤3, 0<y≤2, 0<z≤2, 0<v≤1, and 0<a≤5, M may be manganese (Mn), iron (Fe), nickel (Ni), cobalt (Co), chromium (Cr), copper (Cu), titanium (Ti), zinc (Zn), vanadium (V), zirconium (Zr)), cerium (Ce), or a combination thereof, X may be phosphorus (P), sulfur (S), silicon (Si), or a combination thereof, and Z may be F, Cl, Br, I, or a combination thereof.

NaₓM_{y}(XO₄)_{z}(Z₂O₇)ᵥ Formula 9

In Formula 9, 0<x≤4, 0<y≤3, 0≤z≤3, and 0≤v≤2, M may be manganese (Mn), iron (Fe), nickel (Ni), cobalt (Co), chromium (Cr), copper (Cu), titanium (Ti), zinc (Zn), vanadium (V), zirconium (Zr), cerium (Ce), or a combination thereof, and X and Z each independently may be phosphorus (P), sulfur (S), silicon (Si), or a combination thereof.

NaₓM1O₂ Formula 10

In Formula 10, 0<x≤1, and M1 may be titanium (Ti), vanadium (V), manganese (Mn), cobalt (Co), nickel (Ni), iron (Fe), chromium (Cr), copper (Cu), or a combination thereof.

NaₐNi_{b}M2_{c}M3_{d}M4ₑM5_{f}O₂ Formula 11

In Formula 11, 0.4≤a<1, 0<b<0.5, 0≤c<1, 0≤d<0.5, 0≤e<0.5, 0≤f<0.5, and 0<c+e, M2 may be manganese (Mn), titanium (Ti), zirconium (Zr), or a combination thereof, M3 may be magnesium (Mg), calcium (Ca), copper (Cu), zinc (Zn), cobalt (Co), or a combination thereof, M4 may be manganese (Mn), titanium (Ti), zirconium (Zr), or a combination thereof, and M5 may be aluminum (AI), iron (Fe), cobalt (Co), molybdenum (Mo), chromium (Cr), vanadium (V), scandium (Sc), yttrium (Y), or a combination thereof.

NaₓM1_{y}M2_{z}(CN)₆ Formula 12

In Formula 12, 0<x≤2, 0<y<1, and 0<z<1, and M1 and M2 each independently may be manganese (Mn), nickel (Ni), copper (Cu), cobalt (Co), iron (Fe), zinc (Zn), vanadium (V), chromium (Cr), or a combination thereof.

For example, the amount of the cathode active material included in the cathode active material layer 12 may be about 30 wt % to about 95 wt %, about 40 wt % to about 90 wt %, about 50 wt % to about 80 wt %, or about 50 wt % to about 70 wt %, with respect to the total weight of the cathode active material layer 12.

If the amount of the cathode active material is excessively low, the energy density of an all-solid secondary battery 1 may deteriorate.

### Cathode: Electrolyte

The cathode active material layer 12 may further include, for example, an electrolyte. The electrolyte may be, for example, a sulfide solid electrolyte. The sulfide solid electrolyte included in the cathode 10 may be identical to or different from the sulfide solid electrolyte included in the sulfide electrolyte 30. For details of the sulfide solid electrolyte, refer to the description of the sulfide electrolyte in solid electrolyte.

The solid electrolyte included in the cathode active material layer 12 may have a smaller median particle diameter D50 than that of the solid electrolyte included in the solid electrolyte layer 30. For example, the median particle diameter D50 of the electrolyte included in the cathode active material layer 12 may be 90% or less, 80% or less, 70% or less, 60% or less, 50% or less, 40% or less, 30% or less, or 20% or less, with respect to the median particle diameter D50 of the electrolyte included in the solid electrolyte layer 30. D50 average particle diameter may be, for example, a median particle diameter (D50).

Median particle diameter (D50) may refer to a particle size corresponding to a cumulative volume of 50 vol % as counted from the smallest particle size in a particle size distribution measured by a laser diffraction method.

For example, the amount of the electrolyte included in the cathode active material layer 12 may be about 1 wt % to about 40 wt %, about 5 wt % to about 40 wt %, about 10 wt % to about 40 wt %, or about 20 wt % to about 40 wt %, with respect to the total weight of the cathode active material layer 12.

### Cathode: Conductive Material

The cathode active material layer 12 may further include a conductive material. The conductive material may be, for example, a carbon-containing conductive material, a metal-containing conductive material, or a combination thereof. Examples of the carbon-containing conductive material include graphite, carbon black, acetylene black, Ketjen black, carbon fibers, and a combination thereof. However, the carbon-containing conductive material is not limited to the aforementioned examples and may be any material available as a carbon-containing conductive material in the art. The metal-containing conductive material may be metal powder, metal fibers, or a combination thereof, but without being limited thereto, may any metal-containing conductive material available in the art. For example, the content of the conductive material included in the cathode active material layer 12 may be about 1 wt % to about 30 wt %, about 1 wt % to about 20 wt %, about 1 wt % to about 10 wt %, with respect to a total weight of the cathode active material layer 12. The conductive material may be omitted.

### Cathode: Binder

The cathode active material layer 12 may further include a binder. The binder may be, for example, styrene butadiene rubber (SBR), polytetrafluoroethylene, polyvinylidene fluoride, polyethylene, and the like, but without being limited to the aforementioned examples, may utilize any material used as a binder in the art. The amount of the binder included in the cathode active material layer 12 may be, for example, about 1 wt % to about 10 wt %, or about 1 wt % to about 5 wt %, with respect to the total weight of the cathode active material layer 12. The binder may be omitted.

### Cathode: Other Additives

The cathode active material layer 12 may further include, for example, an additive such as a filler, a coating agent, a dispersing agent, and an ionically conductive aid, in addition to the cathode active material, the solid electrolyte, the binder, and the conductive material described above.

For the filler, coating agent, dispersing agent, and ionically-conductive aid that may be included in the cathode active material layer 12, any known material generally used in an electrode of a sodium all-solid secondary battery 1 may be utilized.

### Cathode: Cathode Current Collector

The cathode current collector 11 may utilize, for example, a plate, a foil, or the like, formed of a stainless steel alloy, indium (In), copper (Cu), magnesium (Mg), titanium (Ti), iron (Fe), cobalt (Co), nickel (Ni), zinc (Zn), aluminum (Al), germanium (Ge), sodium (Na), or a combination thereof. The cathode current collector 11 may be omitted. The cathode current collector 11 may have a thickness of, for example, about 1 μm to about 100 μm, about 1 μm to about 50 μm, about 5 μm to about 25 μm, or about 10 μm to about 20 μm.

For example, the cathode current collector 11 may include a base film, and a metal layer disposed on one side or both sides of the base film. For example, the base film may include a polymer. For example, the polymer may include polyethylene terephthalate (PET), polyethylene (PE), polypropylene (PP), polybutylene terephthalate (PBT), polyimide (PI), or a combination thereof. The metal layer may include, for example, a stainless steel alloy, indium (In), copper (Cu), magnesium (Mg), titanium (Ti), iron (Fe), cobalt (Co), nickel (Ni), zinc (Zn), aluminum (AI), germanium (Ge), sodium (Na), or a combination thereof. If the cathode current collector 11 has the above structure, the weight of the electrodes may be reduced, and consequently, the energy density of the sodium all-solid secondary battery 1 may improve.

### Anode: Binding Layer

Although not shown in the drawings, a binding layer may be further included between the cathode 10 and the solid electrolyte layer 30.

By including the binding layer between the cathode 10 and the solid electrolyte layer 30, sodium ions may be transferred between the cathode 10 and the solid electrolyte layer 30, and the contact capability between the cathode 10 and the solid electrolyte layer 30 may improve.

The binding layer may include a metal capable of forming an alloy with sodium (an alloyable metal), a sodium ion-conductive material, or a combination thereof. The binding layer may include, for example, a metal capable of forming an alloy and/or a compound with sodium.

The metal capable of forming an alloy and/or a compound with sodium may include, for example, a first metal. The first metal may include, for example, gold (Au), tin (Sn), titanium (Ti), zinc (Zn), platinum (Pt), silicon (Si), silver (Ag), bismuth (Bi), germanium (Ge), lead (Pb), antimony (Sb), or a combination thereof. The binding layer may be, for example, a metal layer containing a first metal.

The binding layer containing a metal capable of forming an alloy and/or compound with sodium may have, for example, a thickness smaller than a thickness of the solid electrolyte layer 30. The thickness of the binding layer may be, for example, 50% or less, 30% or less, 10% or less, or 1% or less with respect to the thickness of the solid electrolyte layer 30. The thickness of the binding layer may be, for example, about 0.001% to about 50%, about 0.01% to about 30%, about 0.01% to about 10%, or about 0.01% to about 1%, with respect to the thickness of the solid electrolyte layer 30. The thickness of the binding layer may be, for example, 100 nanometers (nm) or less, 80 nm or less, 70 nm or less, 60 nm or less, or 50 nm or less. The thickness of the binding layer may be, for example, about 1 nm to 100 nm, about 2 nm to about 80 nm, about 3 nm to about 70 nm, about 4 nm to about 60 nm, or about 5 nm to about 50 nm. With the binding layer having a thickness within the aforementioned ranges, sodium ion transfer may be facilitated.

The binding layer may include, for example, a sodium ion-conducting material. The sodium ion-conducting material may include, for example, a solid electrolyte, a gel electrolyte, a liquid electrolyte, an ionic liquid, or a combination thereof. Examples of the solid electrolyte include a sulfide solid electrolyte, an oxide solid electrolyte, a polymer solid electrolyte, or a combination thereof.

### Anode (I): Plated-Type Anode

Referring to FIGS. 1 and 2, the anode 20 may be a plated-type anode 20. In an all-solid secondary battery 1 including the plated-type anode 20, a sodium metal layer may be further plated between the anode active material layer 22 and the anode current collector 21 by charging. Because the sodium source of the anode 20 can be omitted in the all-solid secondary battery 1 including the plated-type anode 20, the energy density of the all-solid secondary battery 1 may further improve.

### Anode (I): Anode Active Material

Referring to FIGS. 1 to 2, an anode 20 may include an anode active material layer 22. The anode active material layer 22 may include, for example, an anode active material and a binder.

Anode active materials may include one or more of a carbon-containing anode active material or a metal-containing anode active material.

The carbon-containing anode active material may include, for example, amorphous carbon, crystalline carbon, porous carbon, or a combination thereof.

The carbon-containing anode active material may be, for example, an amorphous carbon. The amorphous carbon may be, for example, carbon black (CB), acetylene black (AB), furnace black (FB), Ketjen black (KB), graphene, and the like, but without being necessarily limited thereto, may be any material categorized as amorphous carbon in the art. Amorphous carbon is carbon with no crystalline structure or with an extremely low degree of crystallinity and as such, may be distinct from crystalline carbon or graphitic carbon.

The carbon-containing anode active material may be porous carbon, for example. For example, pores included in the porous carbon may have a pore volume of about 0.1 cubic centimeters per gram (cc/g) to about 10.0 cc/g, about 0.5 cc/g to about 5 cc/g, or about 0.1 cc/g to about 1 cc/g. For example, pores included in the porous carbon may have an average pore diameter of about 1 nm to about 50 nm, about 1 nm to about 30 nm, or about 1 nm to about 10 nm. The BET specific surface of the porous carbon may be, for example, about 100 square meters per gram (m²/g) to about 3,000 m²/g.

The metal anode active material may include, for example, gold (Au), tin (Sn), titanium (Ti), zinc (Zn), platinum (Pt), silicon (Si), silver (Ag), bismuth (Bi), germanium. (Ge), lead (Pb), antimony (Sb), or a combination thereof, but without being necessarily limited thereto, may be any metal anode active material in the art that is capable of forming an alloy or a compound with sodium. For example, nickel (Ni) does not form an alloy with sodium and is therefore not regarded as a metal-containing anode active material.

The anode active material layer 22 may include a single anode active material, or a mixture of multiple different types of anode active materials among the aforementioned anode active materials. For example, the anode active material layer 22 may include amorphous carbon alone, or may include gold (Au), tin (Sn), titanium (Ti), zinc (Zn), platinum (Pt), silicon (Si), silver (Ag) or a combination thereof. Alternatively, the anode active material layer 22 may include a mixture of amorphous carbon with one or more of gold (Au), tin (Sn), titanium (Ti), zinc (Zn), platinum (Pt), silicon (Si), silver (Ag), or a combination thereof. A mixing ratio of amorphous carbon to the metal(s) described herein, such as gold (Au), in such a mixture, may be about 99:1 to about 1:99, about 10:1 to about 1:2, about 5:1 to about 1:1, or about 4:1 to about 2:1 in weight ratio, but without being necessarily limited thereto, the mixing ratio may be selected according to a required feature of the sodium all-solid secondary battery 1. If the anode active material has the above composition, the cycling performance of the sodium all-solid secondary battery 1 may further improve.

The anode active material layer 22 may include an anode active material, and the anode active material may include, for example, a mixture of first particles and second particles, the first particles being composed of amorphous carbon, and the second particles being composed of a metal. The metal may include, for example, gold (Au), tin (Sn), titanium (Ti), zinc (Zn), platinum (Pt), silicon (Si), silver (Ag), bismuth (Bi), germanium (Ge), lead (Pb), antimony (Sb), and the like. The content of the second particles may be about 1 wt % to about 99 wt %, about 1 wt % to about 60 wt %, about 8 wt % to about 60 wt %, about 10 wt % to about 50 wt %, about 15 wt % to about 40 wt %, or about 20 wt % to about 30 wt %, with respect to the total weight of the mixture. If the content of the second particles is within the aforementioned ranges, the cycling performance of the sodium all-solid secondary battery 1 may further improve.

The anode active material may have, for example, a particulate form. The anode active material having a particulate form may have an average particle diameter of, for example, 4 micrometers (μm) or less, 3 μm or less, 2 μm or less, 1 μm or less, 500 nm or less, 300 nm or less, or 100 nm or less. The anode active material having a particulate form may have an average particle diameter of, for example, about 10 nm to about 4 μm, about 10 nm to about 3 μm, about 10 nm to about 2 μm, about 10 nm to about 1 μm, about 10 nm to about 500 nm, about 10 nm to about 300 nm, or about 10 nm to about 100 nm. With the anode active material having an average particle diameter within the above ranges, reversible absorption and/or desorption of sodium during charging/discharging may be facilitated. The average particle diameter of the anode active material may be, for example, a median particle diameter (D50) as measured by a laser-type particle size distribution analyzer.

### Anode (I): Binder

The binder included in the anode active material layer 22 may be, for example, styrene butadiene rubber (SBR), polytetrafluoroethylene, polyvinylidene fluoride, polyethylene, a vinylidene fluoride/hexafluoropropylene copolymer, polyacrylonitrile, polymethylmethacrylate, or the like. However, the binder is not limited to the aforementioned examples and may be any material available as a binder in the art. The binder may be composed of a single type of binder, or multiple binders of different types.

Because the anode active material layer 22 includes a binder, the anode active material layer 22 may be stabilized on the anode current collector 21. Further, crack formation in the anode active material layer 22 may be suppressed, despite volume changes and/or displacement of the anode active material layer 22 during charging and discharging processes. For example, if the anode active material layer 22 does not contain any binder, the anode active material layer 22 may be easily delaminated from the anode current collector 21. At an area where the anode current collector 21 is exposed as a result of delamination of the anode active material layer 22 from the anode current collector 21, the anode current collector 21 may come in contact with the solid electrolyte layer 30, thus increasing the likelihood of a short circuit occurring. For example, the anode active material layer 22 may be prepared by applying and drying a slurry having dispersed therein materials forming the anode active material layer 22 on the anode current collector 21. By including a binder in the anode active material layer 22, stable dispersion of the anode active materials within the slurry may be achieved. For example, if the slurry is to be applied onto the anode current collector 21 by a screen-printing method, it may be possible to prevent the screen from clogging (for example, clogging by agglomerates of the anode active material).

### Anode (I): Other Additives

The anode active material layer 22 may further include other additives used in a conventional sodium all-solid secondary battery, such as a filler, a coating agent, a dispersing agent, an ionically conductive aid, and the like.

### Anode (I): Anode Active Material Layer

Referring to FIGS. 1 and 2, the ratio (B/A) of initial charge capacity (B) of the anode active material layer 22 to initial charge capacity (A) of the cathode active material layer may be, for example, less than 1, 0.8 or less., 0.6 or less, 0.45 or less, 0.4 or less, 0.3 or less, 0.2 or less, or 0.1 or less. The initial charge capacity of the cathode active material layer 12 may be determined at a maximum charging voltage vs. Na/Na⁺ from a first open circuit voltage. The initial charge capacity of the anode active material layer 22 may be determined at 0.01 volts (V) vs. Na/Na⁺ from a second open circuit voltage. The maximum charging voltage may be determined by the type of the cathode active material.

The maximum charging voltage may be, for example, 1.5 V, 2.0 V, 2.5 V, 3.0 V, 3.5 V, 4.0 V, 4.2 V, or 4.3 V. The ratio (B/A) of initial charge capacity (B) of the anode active material layer to initial charge capacity (A) of the cathode active material layer may be, for example, about 0.01 to about 0.5, about 0.01 to about 0.4, or about 0.05 to about 0.1.

The initial charge capacity (milliampere-hour, mAh) of the cathode active material layer 12 may be obtained by multiplying the charge specific capacity (milliampere-hour per gram, mAh/g) of the cathode active material layer 12 by the mass (grams, g) of a cathode active material in the cathode active material layer 12. If multiple types of cathode active materials are used, the product of charge specific density x mass may be calculated for each cathode active material, and the sum of these products may be defined as initial charge capacity of the cathode active material layer 12. The initial charge capacity of the anode active material layer 22 may also be calculated in the same manner.

The initial charge capacity of the anode active material layer 22 may be obtained by multiplying the charge specific density (mAh/g) of an anode active material by the mass of the anode active material in the anode active material layer 22. If multiple types of anode active materials are used, the product of charge specific density x mass may be calculated for each anode active material, and the sum of these products may be defined as initial charge capacity of the anode active material layer 22. The charge specific density of each of the cathode active material and the anode active material may be measured using an all-solid half-cell that uses sodium metal as a counter electrode. The initial charge capacity of each of the cathode active material layer 12 and the anode active material layer 22 may be directly measured by using an all-solid half-cell at a constant current density, for example, at 0.1 milliamperes per square centimeter (mA/cm²). For the cathode, this measurement may be made by charging from a first open circuit voltage (OCV) to a maximum charge voltage, for example, 3.0 V (vs. Na/Na⁺). For the anode, this measurement may be made by charging from a second OCV to 0.01 V with respect to the anode, for example, sodium metal. For example, the all-solid half-cell having the cathode active material layer may be charged from the first OCV to 3.0 V with a constant current of 0.1 mA/cm², and the all-solid half-cell having the anode active material layer may be charged from the second OCV to 0.01 V with a constant current of 0.1 mA/cm².

For example, the current density during the constant current charging may be 0.2 mA/cm² or 0.5 mA/cm². The all-solid half-cell having the cathode active material layer may be charged from the first OCV to, for example, 2.5 V, 2.0 V, 3.5 V, or 4.0 V. The maximum charge voltage of the cathode active material layer may be determined according to the maximum voltage of a cell that satisfies the safety conditions described in JISC8712:2015 by the Japanese Standards Association.

If the charge capacity of the anode active material layer 22 is excessively small, the thickness of the anode active material layer 22 becomes extremely small, and thus, the anode active material layer 22 may be disintegrated by sodium dendrites formed between the anode active material layer 22 and the anode current collector 21 during repeated charging/discharging processes, thus making it difficult to improve the cycling performance of the sodium all-solid secondary battery 1. If the charge capacity of the anode active material layer 22 is excessively large, the energy density of the sodium all-solid secondary battery 1 may decrease, and the internal resistance of the sodium all-solid secondary battery 1 by the anode active material layer 22 may increase, thus making it difficult to improve the cycling performance of the sodium all-solid secondary battery 1.

For example, the anode active material layer 22 may have a thickness of 50% or less, 40% or less, 30% or less, 20% or less, 10% or less, or 5% or less, with respect to a thickness of the cathode active material layer 12. For example, the anode active material layer 22 may have a thickness of about 1% to about 50%, about 1% to about 40%, about 1% to about 30%, about 1% to about 20%, about 1% to about 10%, or about 1% to about 5%, with respect to the thickness of the cathode active material layer 12. For example, the anode active material layer 22 may have a thickness of about 1 μm to about 20 μm, about 2 μm to about 15 μm, or about 3 μm to about 10 μm. If the thickness of the anode active material layer 22 is excessively small, the anode active material layer 22 may be disintegrated by sodium dendrites formed between the anode active material layer 22 and the anode current collector 21, thus making it difficult to improve the cycling performance of the sodium all-solid battery 1. If the thickness of the anode active material layer 22 is excessively large, the energy density of the sodium all-solid secondary battery 1 may decrease, and the internal resistance of the sodium all-solid secondary battery 1 by the anode active material layer 22 may increase, thus making it difficult to improve the cycling performance of the sodium all-solid secondary battery 1. If the thickness of the anode active material layer 22 decreases, for example, the initial charge capacity of the anode active material layer 22 also decreases.

### Anode (I): Binding Layer

Although not shown in the drawings, in a case in which the sodium all-solid secondary battery 1 further includes an oxide electrolyte in addition to the sulfide solid electrolyte 30 between the anode 30 and the cathode, a binding layer may be further included between the anode and the oxide solid electrolyte. The binding layer may include a metal capable of forming an alloy with sodium (an alloyable metal), or may include an alloy of sodium with the metal. The metal capable of forming an alloy with sodium may include, for example, a second metal. The second metal may include, for example, gold (Au), tin (Sn), titanium (Ti), zinc (Zn), platinum (Pt), silicon (Si), silver (Ag), bismuth (Bi), germanium (Ge), lead (Pb), antimony (Sb), or a combination thereof. Because a binding layer may be disposed between the anode 20 and the solid electrolyte layer 30, and the binding layer includes a second metal, the cycling performance of the sodium all-solid secondary battery 1 may further improve.

The thickness of the binding layer may be, for example, 100 nm or less, 80 nm or less, 70 nm or less, 60 nm or less, or 50 nm or less. The thickness of the binding layer may be, for example, about 1 nm to 100 nm, about 2 nm to about 80 nm, about 3 nm to about 70 nm, about 4 nm to about 60 nm, or about 5 nm to about 50 nm. With the binding layer having a thickness in the aforementioned ranges, the cycling performance of the all-solid secondary battery 1 may further improve. If the thickness of the binding layer is excessively small, it may be difficult to provide an effect as an anode active material layer. If the thickness of the binding layer increases excessively, the cycling performance of the all-solid secondary battery 1 may deteriorate due to increased internal resistance.

The thickness of the anode active material layer 22 may be, for example, larger than the thickness of the binding layer. The thickness of the binding layer may be 50% or less, 40% or less, 30% or less, 20% or less, 10% or less, 5% or less, or 1% or less with respect to the thickness of the anode active material layer 22. The binding layer containing a metal capable of forming an alloy with sodium may have a thickness of, for example, about 0.01% to about 10%, about 0.01% to about 5%, about 0.01% to about 1%, or about 0.01% to about 0.1%, with respect to the thickness of the anode active material layer 22. The binding layer containing a sodium ion-conducting material may have a thickness of, for example, about 1% to about 50%, about 1% to about 40%, about 1% to about 30%, about 1% to about 20%, or about 1% to about 10%, with respect to the thickness of the anode active material layer 22.

### Anode (I): Metal Layer

Referring to FIG. 2, the sodium all-solid secondary battery 1 may further include, after charging, a metal layer 23 that is disposed, for example, between the anode current collector 21 and the anode active material layer 22. The metal layer 23 may be a metal layer containing sodium metal or a sodium alloy. Accordingly, the metal layer 23 may act as a sodium reservoir. The sodium alloy may include, for example, a Na—Sn alloy, a Na—In alloy, a Na—Ag alloy, a Na—Au alloy, a Na—Zn alloy, a Na—Ge alloy, a Na—Si alloy, or the like, but without being limited thereto, may be any material available as a sodium alloy in the art. The metal layer 23 may be composed of sodium or one of such alloys, or may be composed of various types of alloys. The metal layer 23 may be, for example, a plated layer. The metal layer 23 may be plated, for example, between the anode active material layer 22 and the anode current collector 21 during charging of the sodium all-solid secondary battery 1.

The second anode active material layer 23 is not limited to any particular thickness, but may have a thickness of, for example, about 1 μm to about 500 μm, about 1 μm to about 200 μm, about 1 μm to about 150 μm, about 1 μm to about 100 μm, or about 1 μm to about 50 μm. If the metal layer 23 is excessively thin, the metal layer 23 may fail to sufficiently function as a sodium reservoir. With the metal layer 23 having an excessively large thickness, the mass and volume of the sodium all-solid secondary battery 1 may increase, and the cycling performance of the sodium all-solid secondary battery 1 may rather deteriorate.

In some embodiments, the metal layer 23 in the sodium all-solid secondary battery 1 may be disposed, for example, between the anode current collector 21 and the anode active material layer 22 prior to assembly of the sodium all-solid secondary battery 1. In a case in which the metal layer 23 is positioned between the anode current collector 21 and the anode active material layer 22 prior to assembly of the sodium all-solid battery 1, the metal layer 23, as a metal layer containing sodium, may act as a sodium reservoir. For example, a sodium foil may be disposed between the anode current collector 21 and the anode active material layer 22 prior to assembly of the sodium all-solid secondary battery 1.

If the metal layer 23 is to be plated by charging after assembly of the sodium all-solid secondary battery 1, because the metal layer 23 is not included at the time of assembly of the sodium all-solid secondary battery 1, the sodium all-solid secondary battery 1 may have an increased energy density. When charging the sodium all-solid secondary battery 1, the charging may be performed to exceed the charge capacity of the anode active material layer 22. The anode active material layer 22 may be then overcharged. At the beginning of charging, sodium may be intercalated into the anode active material layer 22. The anode active materials included in the anode active material layer 22 may form an alloy or a compound with sodium ions migrated from the cathode 10. If the charging is performed to exceed the capacity of the anode active material layer 22, sodium may be plated, for example, on the back surface of the anode active material layer 22, e.g., between the anode current collector 21 and the anode active material layer 22, and the metal layer 23 may be formed by the plated sodium. The metal layer 23 may be a metal layer mainly including sodium, such as sodium metal. This result may be attributed to the fact that the anode active material included in the anode active material layer 22 includes a material that forms an alloy or compound with sodium. During discharge, sodium in metal layers 23 and the anode active material layer 22 may be ionized and migrate towards the cathode 10. It is possible to use sodium as an anode active material in the sodium all-solid secondary battery 1. Additionally, because the anode active material layer 22 covers the metal layer 23, the anode active material layer 22 may function not only as a protective layer for the metal layer 23, but also to suppress plating and growth of sodium dendrites. It may be possible to suppress a short circuit and capacity fading in the sodium all-solid secondary battery 1 and thus, improve the cycling performance of the sodium all-solid secondary battery 1. If the metal layer 23 is to be disposed by charging after assembly of the sodium all-solid secondary battery 1, the anode 20, that is, the anode current collector 21, the anode active material layer 22, and the area therebetween may be a sodium (Na)-free region free of Na while in the initial state or a fully discharged state of the sodium all-solid secondary battery 1.

### Anode (I): Anode Current Collector

The anode current collector 21 may be formed of a material that does not react with sodium, e.g., does not form an alloy or a compound with sodium. The material forming the anode current collector 21 may include, for example, a stainless steel alloy, indium (In), copper (Cu), titanium (Ti), iron (Fe), cobalt (Co), nickel (Ni), and the like. However, the material forming the anode current collector 21 is not necessarily limited to the aforementioned materials but may be any material available as an electrode current collector in the art. The anode current collector 21 may be formed of one type of the aforementioned metals, an alloy of two or more types metals thereof, or a covering material. The anode current collector 21 may be, for example, a plate type or a foil type.

Although not shown in the drawings, the sodium all-solid secondary battery 1 may further include, for example, a thin film including a third metal capable of forming an alloy with sodium, between the anode current collector 21 and the anode active material layer 22. The thin film may be disposed on one side of the anode current collector 21. The third metal may include, for example, gold (Au), tin (Sn), titanium (Ti), zinc (Zn), platinum (Pt), silicon (Si), silver (Ag), bismuth (Bi), and germanium. (Ge), lead (Pb), antimony (Sb), or a combination thereof, but without being necessarily limited thereto, may be any element in the art that is alloyable with sodium. The thin film may be composed of one of the aforementioned metals or may be composed of an alloy of various kinds of metals. With the thin film disposed between the anode current collector 21 and the anode active material layer 22, the form of the metal layer 23 being plated between the thin film and the anode active material layer 22 may be further flattened, and the cycling performance of the sodium all-solid battery 1 may further improve.

For example, the thin film may have a thickness of about 1 nm to about 800 nm, about 10 nm to about 700 nm, about 50 nm to about 600 nm, or about 100 nm to about 500 nm. If the thickness of the thin film is less than 1 nm, it may be difficult to achieve functions attributable to the thin film. If the thickness of the thin film is excessively large, the thin film may be induced to intercalate sodium by itself, which decreases the amount of sodium being plated at the anode and as a result, the energy density of an all-solid battery may decrease, and the cycling performance of the sodium all-solid secondary battery 1 may deteriorate. The thin film may be positioned on the anode current collectors 21 by a vacuum deposition method, a sputtering method, a plating method or the like, but is not limited to the aforementioned methods and may be any method available in the art that is capable of forming the thin film.

For example, the anode current collector 21 may include a base film, and a metal layer disposed on one side or both sides of the base film. For example, the base film may include a polymer. For example, the polymer may include polyethylene terephthalate (PET), polyethylene (PE), polypropylene (PP), polybutylene terephthalate (PBT), polyimide (PI), or a combination thereof. For example, the metal layer may include a stainless steel alloy, indium (In), copper (Cu),, titanium (Ti), iron (Fe), cobalt (Co), nickel (Ni), or a combination thereof. With the anode current collector 21 having the aforementioned structure, the weight of the electrode may be reduced, and as a result, the energy density of an all-solid secondary battery may improve.

### Cathode (I): Anodeless

The anode 20 may include the anode current collector 21 alone without anode active material layers. By charging the sodium all-solid secondary battery 1, an anode active material layer may be plated between the solid electrolyte layer 30 and the anode current collector 21. The anode active material layer may be, for example, a sodium metal layer or a sodium alloy layer. The charged sodium all-solid secondary battery 1 may include, for example, an anode active material layer 22 as shown in FIG. 1, wherein the anode active material layer may be the sodium metal layer or sodium alloy layer described above.

Because the anode 20 includes the anode current collector 21 alone, the energy density of the sodium all-solid secondary battery 1 may further improve.

Anode (II): Non-Plated type Anode

The anode may be a non-plated type anode. In the non-plated type anode, sodium may be intercalated into the anode active material layer by charging in an all-solid secondary battery, and there may be no sodium metal layer further plated between the anode active material layer and the anode current collector. In an all-solid secondary battery including a non-plated type anode, because the volume change in the anode during charging and discharging is alleviated, the lifespan characteristics of the all-solid secondary battery may further improve.

### Anode (II): Anode Active Material

The anode active material layer may contain an anode active material, a conductive material, and a binder.

The respective amounts of the anode active material, conductive material, and binder used in the anode active material layer may be at a level commonly used in a sodium all-solid secondary battery. Depending on the intended use and configuration of the sodium all-solid secondary battery, one or more of the conductive materials and the binder may be omitted.

Examples of the anode active material include a metal-containing anode active material such as metal Na, metal Sn, metal Bi, metal Zn, Sn—Cu alloy, and Bi—Cu alloy; a carbon-containing anode active material such as hard carbon and soft carbon; an oxide anode active material containing Ti and/or Nb; or a combination thereof. However, without being limited to the aforementioned examples, any anode active material available in the art may be used.

The oxide anode active material containing Ti and/or Nb may have improved safety. For example, an oxide anode active material whose redox potential accompanied by charging and discharging is 1.5 V (vs. Na/Na⁺) or less may be used.

The oxide anode active material may include a crystalline phase represented by Na₄TiO(PO₄)₂ or Na₅Ti(PO₄)₃.

The amount of the anode active material may be about 50 wt % to about 99 wt %, or about 60 wt % to about 90 wt % with respect to the total weight of the anode active material layer.

### Anode (II): Binder

The binder included in the anode active material layer may be selected from the binders used in the plated-type anode.

Examples of the binder include a vinylidene fluoride/hexafluoropropylene copolymer, polyvinylidene fluoride, polyacrylonitrile, polymethyl methacrylate, polytetrafluoroethylene (PTFE), a styrene butadiene rubber polymer, polyacrylic acid, sodium-substituted polyacrylic acid, polyamide-imide, polyimide, or a combination thereof, but the present disclosure is not limited to the aforementioned examples, and any suitable binder in the art may be utilized.

The amount of the binder may be about 0.1 wt % to about 10 wt %, or about 0.1 wt % to about 5 wt %, with respect to the total weight of the anode active material layer.

### Anode (II): Conductive Material

The anode active material layer may further include a conductive material. The conductive material may include a fibrous conductive material, a particulate conductive material, or a combination thereof. Examples of the conductive material include graphite, carbon black, acetylene black, Ketjen black, carbon fibers, carbon nanotubes, carbon nanofibers, metal powder, and the like; however, without being limited to the aforementioned examples, any material available as a conductive material in the art may be utilized. The conductive material may be omitted.

The amount of the conductive material may be about 0.1 wt % to about 10 wt %, or about 0.1 wt % to about 5 wt %, with respect to the total weight of the anode active material layer.

### Anode (II): Other Additives

The anode active material layer may further include other additives used in a conventional sodium all-solid secondary battery 1, such as a filler, a coating agent, a dispersing agent, an ionically conductive aid, and the like.

### Anode (II): Anode Active Material Layer

The ratio B/A of initial charge capacity B of an anode active material layer to initial charge capacity A of a cathode active material layer may be, for example, 1 or more. The initial charge capacity of the cathode active material layer and the initial charge capacity of the anode active material layer may be measured by the same method as the plated-type anode described above. The ratio (B/A) of initial charge capacity (B) of an anode active material layer to initial charge capacity (A) of a cathode active material layer may be, for example, about 1.0 to about 1.3, about 1.0 to about 1.2, about 1.0 to about 1.1, or about 1.01 to about 1.1. The initial charge capacity B of an anode active material layer 22 may be more than the initial charge capacity A of a cathode active material layer. Because the initial charge capacity B of the anode active material layer is more than the initial charge capacity A of the cathode active material layer, the plating of sodium metal may be suppressed, and the growth of sodium dendrites may be suppressed.

### Anode (II): Anode Current Collector

The anode current collector may be selected from the anode current collectors used in the plated-type anode described above.

### Sodium All-Solid Secondary Battery: Bi-Cell Structure

Although not shown in the drawings, a sodium all-solid secondary battery may have a bi-cell structure including two anodes corresponding to both sides of one cathode, or including two cathodes corresponding to both sides of one anode.

For example, in a sodium all-solid secondary battery, the anode may include a first anode on one side of the cathode, and a second anode on the other side opposite to the one side of the cathode. The electrolyte may include, for example, a first electrolyte between the cathode and the first anode, and a second electrolyte between the cathode and the second anode. A sodium all-solid secondary battery may have a structure in which the first anode, the first electrolyte, the cathode, the second electrolyte, and the second anode are arranged in this order. At least one of the first electrolyte and the second electrolyte may include, for example, the sulfide solid electrolyte of Formula 1 according to an embodiment. Because the sodium all-solid secondary battery has a bi-cell structure, crack formation in the cathode and/or the anode may be suppressed during a press process during manufacturing, and volume changes of the cathode during charging and discharging may be more effectively accommodated. The cycling performance of a sodium all-solid secondary battery may improve.

For example, in the sodium all-solid secondary battery, the cathode may include a first cathode on one side of the anode, and a second cathode on the other side opposite to the one side of the anode. The electrolyte may include, for example, a third electrolyte between the anode and the first cathode, and a fourth electrolyte between the anode and the second cathode. A sodium all-solid secondary battery may have a structure in which the first cathode, the third electrolyte, the anode, the fourth electrolyte, and the second cathode are arranged in this order. At least one of the third electrolyte and the fourth electrolyte may be, for example, the sulfide solid electrolyte according to an embodiment. Because the sodium all-solid secondary battery has a bi-cell structure, crack formation in the anode and/or the cathode may be suppressed during a press process during manufacturing, and volume changes of the anode during charging and discharging may be more effectively accommodated. The cycling performance of a sodium all-solid secondary battery may improve.

The present inventive concept will be described in greater detail through the following examples and comparative examples. However, it will be understood that the examples are provided only to illustrate the present disclosure and not to be construed as limiting the scope of the present disclosure.

### Preparation of Solid Electrolyte

### Preparation Example 1: Na₃P_{0.8}W_{0.1}Si_{0.1}S₄

A precursor mixture was prepared by mixing Na₂S, P₂S₅, WS₂, sulfur (S) particles, and SiS₂ in a stoichiometric amount so as to produce Na₃P_{0.8}W_{0.1}Si_{0.1}S₄, and the precursor mixture was ball-milled at a rate of 600 rpm for 3 hours by planetary ball milling. The milling time was 2 minutes, followed by a rest time of 5 minutes. This cycle was repeated 90 times in total.

The solid electrolyte powder was introduced into a Pyrex glass tube, and the opening of the tube was sealed by a torch under a vacuum reduced-pressure state. The sealed glass sample was heat-treated in a box furnace at 550° C. for 12 hours to prepare a solid electrolyte.

### Preparation Example 2: Na_{3.1}P_{0.8}W_{0.1}Al_{0.1}S₄

A solid electrolyte was prepared following the same process as Preparation Example 1, except that when preparing the precursor mixture, Na₂S, P₂S₅, WS₂, sulfur (S) particles, and Al₂S₃ were mixed in stoichiometric amount so as to produce Na_{3.1}P_{0.8}W_{0.1}Al_{0.1}S₄.

### Preparation Example 3: Na₃P_{0.8}W_{0.1}Sn_{0.1}S₄

A solid electrolyte was prepared following the same process as Preparation Example 1, except that when preparing the precursor mixture, Na₂S, P₂S₅, WS₂, sulfur (S), and SnS₂ (tin sulfide) were mixed stoichiometrically so as to produce Na₃P_{0.8}W_{0.1}Sn_{0.1}S₄. Preparation Example 4: Na_{2.9}P_{0.8}W_{0.1}Si_{0.1}S_{3.9}Cl_{0.1}

A solid electrolyte was prepared following the same process as Preparation Example 1, except that when preparing the precursor mixture, Na₂S, P₂S₅, WS₂, sulfur (S), SiS₂, and NaCl were mixed stoichiometrically so as to produce Na_{2.9}P_{0.8}W_{0.1}Si_{0.1}S_{3.9}Cl_{0.1}.

### Preparation Example 5: Na₃P_{0.8}W_{0.1}Al_{0.1}S_{3.9}Cl_{0.1}

A solid electrolyte was prepared following the same process as Preparation Example 1, except that when preparing the precursor mixture, Na₂S, P₂S₅, WS₂, Al₂S₃, and NaCl were mixed in stoichiometric amount so as to produce Na₃P_{0.8}W_{0.1}Al_{0.1}S_{3.9}Cl_{0.1}.

### Preparation Example 6: Na_{2.8}P_{0.9}W_{0.1}S_{3.9}Cl_{0.1}

A solid electrolyte was prepared following the same process as Preparation Example 1, except that when preparing the precursor mixture, Na₂S, P₂S₅, WS₂, sulfur (S), and NaCl were mixed in stoichiometric amount so as to produce Na_{2.8}P_{0.9}W_{0.1}S_{3.9}Cl_{0.1}.

### Preparation Examples 7-8

A solid electrolyte was prepared, except that Na₂S, P₂S₅, WS₂, GeS₂, sulfur (S), and NaCl were mixed in stoichiometric amount so as to produce solid electrolytes having the compositions shown in Table 1 when preparing the precursor mixture.

### Preparation Examples 9-10

A solid electrolyte was prepared, except that Na₂S, P₂S₅, WS₂, GaS₂, sulfur (S), and NaCl were mixed in stoichiometric amount so as to produce solid electrolytes having the compositions shown in Table 1 when preparing the precursor mixture.

### Preparation Example 11

A solid electrolyte was prepared following the same process as Preparation Example 1, except that when preparing the precursor mixture, Na₂S, P₂S₅, WS₂, S, Al₂S₃, NaCl, and NaBr were mixed in stoichiometric amount so as to produce the solid electrolyte shown in Table 1.

### Preparation Example 12

A solid electrolyte was prepared following the same process as Preparation Example 1, except that when preparing the precursor mixture, Na₂S, P₂S₅, WS₂, S, Al₂S₃, and NaCl were mixed in stoichiometric amount so as to produce the solid electrolyte shown in Table 1.

TABLE 1

| Item | Solid Electrolyte Composition |
|---|---|
| Preparation Example 7 | Na₃P_{0.8}W_{0.1}Ge_{0.1}S₄ |
| Preparation Example 8 | Na_{2.9}P_{0.8}W_{0.1}Ge_{0.1}S_{3.9}Cl_{0.1}, |
| Preparation Example 9 | Na_{3.1}P_{0.8}W_{0.1}Ga_{0.1}S₄ |
| Preparation Example 10 | Na₃P_{0.8}W_{0.1}Ga_{0.1}S_{3.9}Cl_{0.1} |
| Preparation Example 11 | Na₃P_{0.8}W_{0.1}Al_{0.1}S_{3.9}Cl_{0.05}Br_{0.05} |
| Preparation Example 12 | Na₃P_{0.7}W_{0.15}Al_{0.15}S_{3.9}Cl_{0.1} |

### Comparative Preparation Example 1: Na₃PS₄

A solid electrolyte was prepared following the same process as Preparation Example 1, except that when preparing the precursor mixture, Na₂S and P₂S₅ were mixed in stoichiometric amount so as to produce Na₃PS₄.

### Comparative Preparation Example 2: Na_{2.9}P_{0.9}W_{0.1}S₄

A solid electrolyte was prepared following the same process as Preparation Example 1, except that when preparing the precursor mixture, Na₂S, P₂S₅, and WS₂ were mixed in stoichiometric amount so as to produce Na_{2.9}P_{0.9}W_{0.1}S₄.

### Comparative Preparation Example 3: Na_{3.1}P_{0.9}Si_{0.1}S₄

A solid electrolyte was prepared following the same process as Preparation Example 1, except that when preparing the precursor mixture, Na₂S, P₂S₅, and SiS₂ were mixed in stoichiometric amount so as to produce Na_{3.1}P_{0.9}Si_{0.1}S₄.

### Comparative Preparation Example 4: Na_{3.2}P_{0.9}Al_{0.1}S₄

A solid electrolyte was prepared following the same process as Preparation Example 1, except that when preparing the precursor mixture, Na₂S, P₂S₅, and Al₂S₃ were mixed in stoichiometric amount so as to produce Na_{3.2}P_{0.9}Al_{0.1}S₄.

### Preparation of Sodium All-Solid Secondary Battery

### Example 1: [Anode Current Collector (SUS)/Anode Active Material Layer (AgC)/Sulfide Solid Electrolyte Layer/Cathode Active Material Layer (Na₃V₂(PO₄)₃)/Cathode Current Collector (SUS)]

### Preparation of Cathode

Na₃V₂(PO₄)₃ was prepared as a cathode active material. Na₃₋ₓPS₄₋ₓClₓ (x=0.0625) was prepared as a sulfide solid electrolyte. As a conductive material, carbon nanotubes (CNTs) were prepared.

The aforementioned materials were mixed in a weight ratio of cathode active material: solid electrolyte: conductive material of 60:35:5 to prepare a cathode mixture. The cathode mixture was obtained by dry mixing, using a ball mill. The cathode mixture obtained by ball-milling formed ionically conductive and electronically conductive networks. The cathode mixture was disposed on one side of a 20 μm-thick SUS cathode current collector and plate-pressed to produce a cathode. The thickness of the cathode was 30 μm.

Preparation of Anode, Solid Electrolyte Layer, and Sodium All-Solid Secondary Battery

As an anode current collector, a 20 μm-thick SUS sheet was prepared. As an anode active material, carbon black (CB) having a primary particle diameter of about 30 nm and silver (Ag) particles having an average particle diameter of about 60 nm were prepared.

In a container containing 4 grams of mixed powder containing carbon black (CB) and silver (Ag) particles in a weight ratio of 3:1, 4 grams of an N-methyl-2-pyrrolidone (NMP) solution containing 7 wt % of PVDF binder (#9300, KUREHA) were added, thereby providing a mixed solution. Next, this mixed solution was stirred while gradually adding NMP thereto, to produce a slurry. The prepared slurry was coated onto a SUS anode current collector by using a bar-coater, and dried in the air at 80° C. for 10 minutes. The obtained laminate was vacuum-dried at 40° C. for 10 hours to form an anode active material layer. The dried laminate was cold roll-pressed with a pressure of 5 ton force per square centimeter (ton-f/cm²) at a rate of 5 meters per second (m/sec) to flatten the surface of the anode active material layer of the laminate.

The sulfide solid electrolyte powder of Preparation Example 1 was added onto the anode active material layer, thereby positioning a sulfide solid electrolyte layer. The cathode was positioned in the central portion of the surface of the sulfide solid electrolyte layer such that the cathode active material layer was in contact with the sulfide solid electrolyte layer. The peripheral portion of the cathode was spaced apart from the peripheral portion of the sulfide solid electrolyte layer. The sulfide solid electrolyte powder of Preparation Example 1 was further placed on a side surface of the cathode such that the cathode was embedded in the sulfide solid electrolyte layer. The SUS cathode current collector of the cathode was exposed on the surface of the sulfide solid electrolyte layer.

The sulfide solid electrolyte disposed on the side surface of the anode corresponds to a gasket, which is an inactive member. A sodium all-solid secondary battery was manufactured by pressing a torque cell during assembly. Because the inactive member is disposed on the side surface of the cathode, it may be possible to prevent a short circuit in the cathode and anode during a pressing process of the torque cell assembly. The sulfide solid electrolyte layer was sintered by pressing, thus leading to improved battery performance.

The thickness of the sulfide solid electrolyte layer was 500 μm. The thickness of the sulfide solid electrolyte layer, that is, the inactive member, disposed on the side surface of the cathode was the same as the thickness of the cathode.

The sodium all-solid secondary battery had a structure of [anode current collector (SUS)/anode active material layer (AgC)/sulfide solid electrolyte layer/cathode active material layer (Na₃V₂(PO₄)₃)/cathode current collector (SUS)].

### Examples 2-12

A sodium all-solid secondary battery was prepared following the same process as Example 1, except that the sulfide solid electrolyte powders of Preparation Examples 2 to 12 were used, respectively, instead of the sulfide solid electrolyte powder of Preparation Example 1.

### Comparative Examples 1-4

A sodium all-solid secondary battery was prepared following the same process as Example 1, except that the sulfide solid electrolyte powders of Comparative Preparation Examples 1 to 4 were used, respectively, instead of the sulfide solid electrolyte powder of Preparation Example 1.

### Evaluation Example 1: Sodium-Ion Conductivity

For the solid electrolytes of Preparation Examples 1 to 6, and the solid electrolytes of Comparative Preparation Examples 1 to 4, alternating current impedance measurements were taken to create an impedance plot, and their respective resistance values were compared. A Solartron SI-1260 was used as an impedance measurement device. Each pellet was measured for sodium ion conductivity, and the results are shown in Table 2.Evaluation Example 2: Interface Resistance Evaluation

A symmetric cell shown in FIG. 3 was prepared using each of the solid electrolytes of Preparation Examples 1 to 6 and the solid electrolytes of Preparation Examples 1 to 4.

As an anode current collector, a 20 μm-thick SUS sheet was prepared. As an anode active material, carbon black (CB) having a primary particle diameter of about 30 nm and silver (Ag) particles having an average particle diameter of about 60 nm were prepared.

In a container containing 4 grams of mixed powder containing carbon black (CB) and silver (Ag) particles in a weight ratio of 3:1, 4 grams of an NMP solution containing 7 wt % of PVDF binder (#9300, KUREHA) were added, thereby providing a mixed solution.

Next, this mixed solution was stirred while gradually adding NMP thereto, to produce a slurry. The prepared slurry was coated onto a SUS anode current collector by using a bar-coater, and dried in the air at 80° C. for 10 minutes. The obtained laminate was vacuum-dried at 40° C. for 10 hours to form an anode active material layer. The dried laminate was cold roll-pressed with a pressure of 5 ton-f/cm² at a rate of 5 m/sec to flatten the surface of the anode active material layer of the laminate.

A symmetric cell shown in FIG. 3 was prepared by introducing sulfide solid electrolyte powder onto the anode active material layer, thereby placing a sulfide solid electrolyte layer.

With respect to each symmetric cell after 24 hours, the impedance of the pellet was measured in an ambient atmosphere at 25° C. by a 2-probe method using electrochemical impedance spectroscopy (EIS) (Solartron 1400A/1455A impedance analyzer) with the method described in Lee, Y. et al. “Lithium Argyrodite Sulfide Electrolytes with High Ionic Conductivity and Air-Stability for All-Solid-State Li-Ion Batteries” ACS Energy Letters, 2022, 7, 171-179. The frequency range was 0.1 hertz (Hz) to 1 megahertz (MHz), and the amplitude voltage was 10 millivolts (mV). Ionic conductivity was calculated using the impedance measurement results as described in Wang, S. et al. “High-Conductivity Argyrodite Li₆PS₅Cl Solid Electrolytes Prepared via Optimized Sintering Processes for All-Solid-State Lithium-Sulfur Batteries” ACS Applied Materials & Interfaces, 2018, 10, 42279-42285.

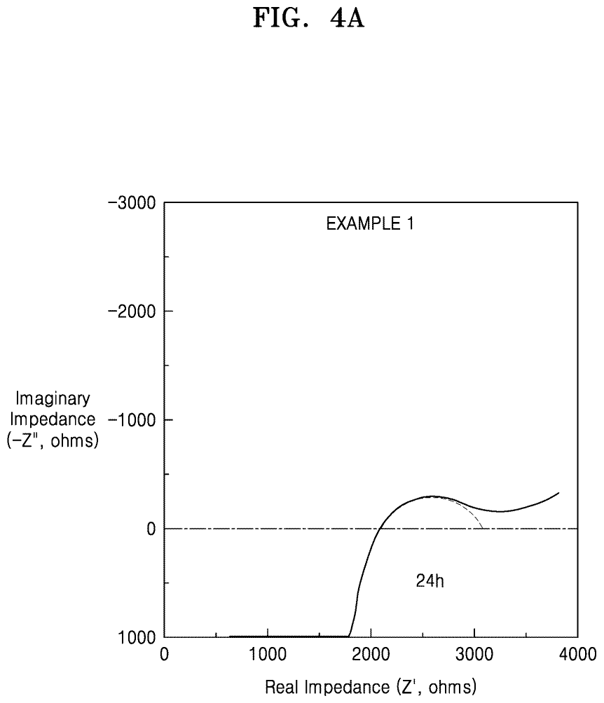

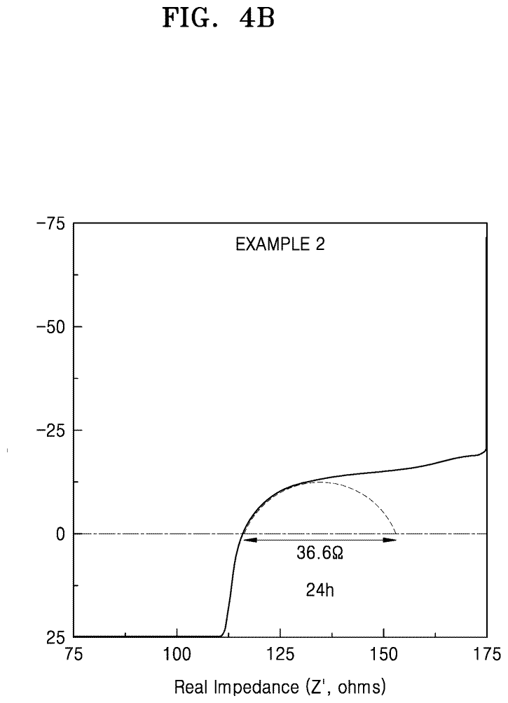

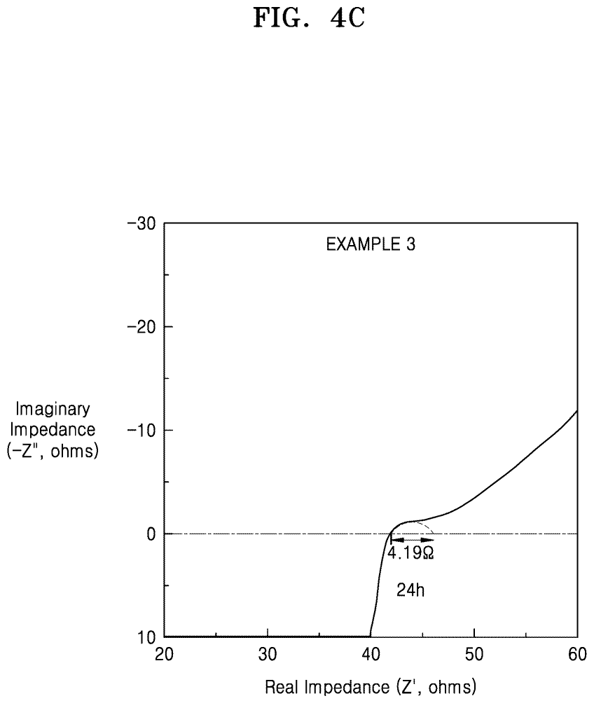

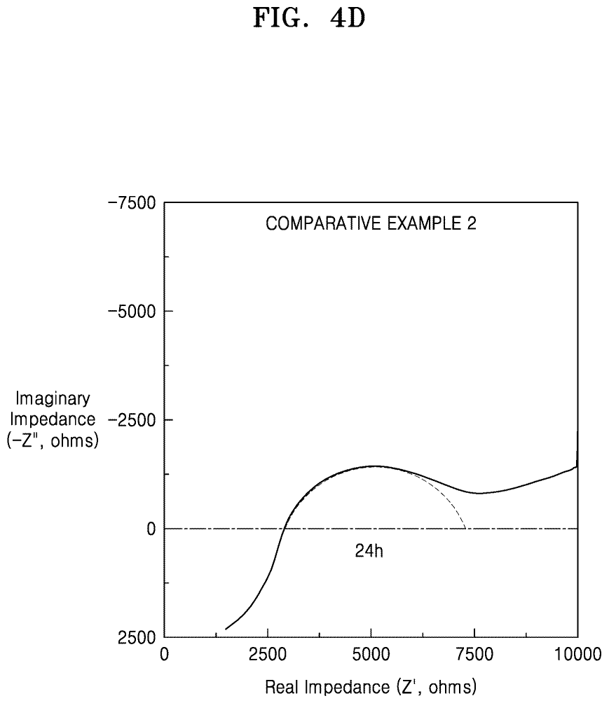

Nyquist plots for the impedance measurement results are shown in FIGS. 4A to 4D. The interfacial resistance was calculated from the Nyquist plots where the diameter of the extrapolated semi-circle is equal to the interfacial resistance in ohms (see FIGS. 4A to 4D). The interfacial resistance after 24 hours is shown in Table 2.

Referring to FIGS. 4A to 4C, the resistance of the all-solid secondary batteries of Examples 1 to 3 shows a significant decrease in interfacial resistance compared to that of Comparative Example 2 shown in FIG. 4D. These results demonstrate that compared to Comparative Example 2, the solid electrolyte in the all-solid secondary batteries of Examples 1 to 3 has improved stability with respect to the sodium anode.

TABLE 2

| | | Na-ion | Interfacial |
|---|---|---|---|
| | | conductivity | resistance (Ω) |
| Item | Composition | (mS/cm) | (after 24 hours) |
| Example 1 | Na₃P_{0.8}W_{0.1}Si_{0.1}S₄ | 1.44 | 730.4 |
| Example 2 | Na_{3.1}P_{0.8}W_{0.1}Al_{0.1}S₄ | 1.59 | 36.6 |
| Example 3 | Na₃P_{0.8}W_{0.1}Sn_{0.1}S₄ | 6.92 | 4.19 |
| Example 4 | Na_{2.9}P_{0.8}W_{0.1}Si_{0.1}S_{3.9}Cl_{0.1} | 1.31 | 38.8 |
| Example 5 | Na₃P_{0.8}W_{0.1}Al_{0.1}S_{3.9}Cl_{0.1} | 7.63 | 60.0 |
| Comparative Example 1 | Na₃PS₄ | 0.01 | — |
| Comparative Example 2 | Na_{2.9}P_{0.9}W_{0.1}S₄ | 5.6 | 1555.8 |
| Comparative Example 3 | Na_{3.1}P_{0.9}Si_{0.1}S₄ | 0.0072 | — |
| Comparative Example 4 | Na_{3.2}P_{0.9}Al_{0.1}S₄ | 0.0070 | — |
| Comparative Example 5 | Na_{2.8}P_{0.9}W_{0.1}S_{3.9}Cl_{0.1} | 0.0409 | — |

As shown in Table 2, the solid electrolytes of Examples 1 to 5 with a structure where part of phosphorus is substituted with two types of trivalent or tetravalent elements have improved sodium ion conductivity compared to the solid electrolyte (Na₃PS₄) of Comparative Example 1 and the solid electrolytes of Comparative Examples 2 to 4, in which part of phosphorus is substituted with one type of element. Among them, the solid electrolyte of Example 5 provided a significant improvement over the solid electrolytes of Comparative Examples 1 to 4.

The solid electrolyte of Example 1 in which part of P is substituted with Si, and the solid electrolyte of Example 2 in which part of P is substituted with Al demonstrated a slightly decreased ionic conductivity compared to the solid electrolyte of Example 3 in which part of P is substituted with Sn. However, due to low interfacial resistance, the interface with the sodium anode was stably maintained after 24 hours as shown in FIGS. 4A to 4C. In addition, as shown in Table 2, the solid electrolyte of Example 3 in which part of P is substituted with Sn was also found to have high ionic conductivity and improved stability.

Meanwhile, the solid electrolyte of Comparative Example 2 provided a significantly increased interfacial resistance after 24 hours, as shown in FIG. 4D.

As shown in Table 1, the solid electrolytes of Examples 1 to 5 had a relatively low interfacial resistance in comparison to the solid electrolytes of Comparative Examples 1 to 5. This result demonstrate that the solid electrolytes of Examples 1 to 5 had a high stability with respect to the sodium anode, compared to the solid electrolytes of Comparative Examples 1 to 5.

As shown in Table 2, the solid electrolyte of Comparative Example 1 in which part of P is substituted with Si showed excellent ionic conductivity, but poor stability with respect to the sodium anode. In addition, the solid electrolytes of Comparative Examples 1, 3, and 4 were found to have poor ionic conductivity and poor stability.

In addition, the solid electrolytes of Preparation Examples 5 to 12, although not shown in Table 2, also demonstrated improved sodium ion conductivity compared to the solid electrolytes of Comparative Examples 1 to 5.Evaluation Example 3: Charge-Discharge Characteristics Test

The sodium all-solid secondary batteries prepared in Examples 1 to 4 and Comparative Examples 1 to 5 were evaluated for charge-discharge characteristics by the following charge-discharge test. The charge-discharge test was performed while the sodium all-solid secondary battery was placed in a constant-temperature bath at 60° C.

Each sodium all-solid secondary battery was charged at a constant current rate of 0.02 mA/cm² to a charge capacity of 1.0 mAh, and then was discharged at the same constant current rate.

The sodium all-solid secondary batteries of Examples 1 to 4 provided a stable charge-discharge profile. Meanwhile, the sodium all-solid secondary batteries of Comparative Examples 1 to 5 had an unstable charge-discharge profile.

As described above, the sodium all-solid secondary battery associated with the present examples may be applied to a variety of portable devices, vehicles, and the like.

While one or more embodiments have been described with reference to the figures, it will be understood by those of ordinary skill in the art that various changes in form and details may be made therein without departing from the spirit and scope of the disclosure as defined by the following claims.

According to one aspect of the present disclosure, a solid electrolyte with improved ionic conductivity and stability may be provided, and the solid electrolyte may be used to provide a sodium all-solid secondary battery with improved cycling performance.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A sulfide solid electrolyte represented by Formula 1:
Na_{3±x}P_{1-(y1+y2)}W_{y1}M_{y2}S_{4-z}X_{z} Formula 1
wherein in Formula 1, M is a trivalent element, a tetravalent element, or a combination thereof, X is a halogen atom, or a combination thereof, 0≤x≤1, 0<y1≤0.5, 0≤z≤1, and 0≤y2≤0.5,
wherein if z=0, y2 is not 0.

2. The solid electrolyte of claim 1,
wherein M is tin, silicon, aluminum, gallium, germanium, or a combination thereof.

3. The solid electrolyte of claim 1,
wherein the solid electrolyte has a sodium ion conductivity at 25° C. of 0.05 millisiemens per centimeter or more.

4. The solid electrolyte of claim 1, wherein in Formula 1, 0.1≤y1≤0.3.

5. The solid electrolyte of claim 1, wherein in Formula 1, 0.01≤z≤0.5.

6. The solid electrolyte of claim 1, wherein the solid electrolyte comprises a compound represented by Formulas 2 to 4, or a combination thereof:
Na_{3±x}P_{1-(y1+y2)}W_{y1}Sn_{y2}S_{4-z}X_{z} Formula 2
wherein in Formula 2, 0≤x≤1, 0<y1<0.5, 0≤z≤1, and 0≤y2≤0.5,
wherein if z=0, y2 is not 0, and X is a halogen atom,
Na_{3±x}P_{1-(y1+y2)}W_{y1}Al_{y2}S_{4-z}X_{z} Formula 3
wherein in Formula 3, 0≤x≤1, 0<y1 0.5, 0≤z≤1, and 0≤y2≤0.5,
wherein if z=0, y2 is not 0, and X is a halogen atom,
Na_{3±x}P_{1-(y1+y2)}W_{y1}Sn_{y2}S_{4-z}X_{z} Formula 4
wherein in Formula 4, 0≤x≤1, 0<y1<0.5, 0≤z≤1, and 0≤y2≤0.5,
wherein if z=0, y2 is not 0, and X is a halogen atom, and
wherein X, x, y1, y2, and z in Formulas 2 to 4 are each independently selected.

7. The solid electrolyte of claim 1,
wherein the solid electrolyte is Na₃P_{0.8}W_{0.1}Si_{0.1}S₄, Na_{3.1}P_{0.8}W_{0.1}Al_{0.1}S₄, Na₃P_{0.8}W_{0.1}Sn_{0.1}S₄, Na_{2.9}P_{0.8}W_{0.1}Si_{0.1}S_{3.9}Cl_{0.1}, Na₃P_{0.8}W_{0.1}Al_{0.1}S_{3.9}Cl_{0.1}, Na_{2.8}P_{0.9}W_{0.1}S_{3.9}Cl_{0.1}, Na_{2.8}P_{0.8}W_{0.2}S_{3.9}Cl_{0.1}, Na_{2.8}P_{0.7}W_{0.3}S_{3.9}Cl_{0.1}, Na_{2.8}P_{0.7}W_{0.3}S_{3.9}Cl_{0.1}, Na₃P_{0.8}W_{0.1}Sn_{0.1}S_{3.9}Cl_{0.1}, Na₃P_{0.8}W_{0.1}Si_{0.05}Sn_{0.05}S₄, Na_{2.9}P_{0.8}W_{0.1}Si_{0.1}S_{3.9}Cl_{0.05}Br_{0.05}, Na₃P_{0.8}W_{0.1}Al_{0.1}S_{3.9}Cl_{0.05}Br_{0.05}, Na_{2.8}P_{0.9}W_{0.1}S_{3.9}Cl_{0.05}Br_{0.05}, Na₃P_{0.8}W_{0.1}Ge_{0.1}S₄, Na_{2.9}P_{0.8}W_{0.1}Ge_{0.1}S_{3.9}Cl_{0.1}, Na_{3.1}P_{0.8}W_{0.1}Ga_{0.1}S₄, Na₃P_{0.8}W_{0.1}Ga_{0.1}S_{3.9}Cl_{0.1}, Na₃P_{0.8}W_{0.15}Si_{0.05}S₄, Na_{3.1}P_{0.8}W_{0.15}Al_{0.05}S₄, Na₃P_{0.8}W_{0.15}Sn_{0.05}S₄, Na_{2.9}P_{0.8}W_{0.15}Si_{0.05}S_{3.9}Cl_{0.1}, Na_{2.9}P_{0.8}W_{0.15}Si_{0.05}S_{3.9} Cl_{0.05}Br_{0.05}, Na₃P_{0.8}W_{0.15}Al_{0.05}S_{3.9}Cl_{0.1}, Na₃P_{0.8}W_{0.15}Al_{0.05}S_{3.9}Cl_{0.05}Br_{0.05}, Na₃P_{0.7}W_{0.15}Si_{0.15}S₄, Na_{3.1}P_{0.7}W_{0.15}Al_{0.15}S₄, Na₃P_{0.7}W_{0.15}Sn_{0.15}S₄, Na_{2.9}P_{0.7}W_{0.15}Si_{0.15}S_{3.9}Cl_{0.1}, Na₃P_{0.7}W_{0.15}Al_{0.15}S_{3.9}Cl_{0.1}, or a combination thereof.

8. The solid electrolyte of claim 1, wherein the solid electrolyte comprises a glass-ceramic phase.

9. The solid electrolyte of claim 9, wherein a symmetric cell containing the solid electrolyte has an interfacial resistance of about 10 ohms to about 2,000 ohms.

10. A sodium all-solid secondary battery comprising:
a cathode; an anode; and a solid electrolyte layer between the cathode and the anode,
wherein the cathode comprises a cathode current collector and a cathode active material layer, and the anode comprises an anode current collector and an anode active material layer,
wherein the cathode, the anode, the solid electrolyte layer, or a combination thereof comprise the solid electrolyte of claim 1.

11. The sodium all-solid secondary battery of claim 10,
wherein the anode active material layer comprises an anode active material and a binder.

12. The sodium all-solid secondary battery of claim 11,
wherein the anode active material comprises a carbon-containing anode active material, a metal-containing anode active material, or a combination thereof.

13. The sodium all-solid secondary battery of claim 12,
wherein the carbon-containing anode active material comprises amorphous carbon, crystalline carbon, porous carbon, or a combination thereof, and the metal-containing anode active material comprises gold, platinum, palladium, silicon, silver, aluminum, bismuth, tin, zinc, or a combination thereof.

14. The sodium all-solid secondary battery of claim 12,
wherein the anode active material comprises a mixture of first particles and second particles, wherein the first particles comprise amorphous carbon, and the second particles comprise a metal or a metalloid,
wherein an amount of the second particles is about 1 weight percent to about 60 weight percent with respect to a total weight of the mixture.

15. The sodium all-solid secondary battery of claim 11, further comprising a metal layer between the anode current collector and the anode active material layer,
wherein the metal layer comprises sodium metal, a sodium alloy, or a combination thereof.

16. The sodium all-solid secondary battery of claim 10,
wherein the cathode active material layer comprises one or more polyanionic compounds selected from Formulas 5 to 9, a layered sodium transition metal oxide represented by one of Formulas 10 and 11, a Prussian blue-type compound represented by Formula 12, or a combination thereof:
NaM(XO₄) Formula 5
wherein in Formula 5, M is manganese, iron, nickel, cobalt, chromium, copper, titanium, zinc, vanadium, zirconium, cerium, or a combination thereof, and X is phosphorus, sulfur, silicon, or a combination thereof,
NaₓM_{y}(XO₄)₃ Formula 6
wherein in Formula 6, 0<x≤3 and 0<y≤2, M is manganese, iron, nickel, cobalt, chromium, copper, titanium, zinc, vanadium, zirconium, cerium, or a combination thereof, and X is phosphorus, sulfur, silicon, or a combination thereof,
NaₓM_{y}(XO₄)Z_{z} Formula 7
wherein in Formula 7, 0<x≤3, 0<y≤2, and 0<z≤1, M is manganese, iron, nickel, cobalt, chromium, copper, titanium, zinc, vanadium, zirconium, cerium, or a combination thereof, X is phosphorus, sulfur, silicon, or a combination thereof, and Z is F, Cl, Br, I, or a combination thereof,
Naₓ(MOₐ)_{y}(XO₄)_{z}Zᵥ Formula 8
wherein in Formula 8, 0<x≤3, 0<y<2, 0<z≤2, 0<v≤1, and 0<a≤5, M is manganese, iron, nickel, cobalt, chromium, copper, titanium, zinc, vanadium, zirconium, cerium, or a combination thereof, X is phosphorus, sulfur, silicon, or a combination thereof, and Z is F, Cl, Br, I, or a combination thereof,
NaₓM_{y}(XO₄)_{z}(Z₂O₇)ᵥ Formula 9
wherein in Formula 9, 0<x≤4, 0<y≤3, 0≤z≤3, and 0≤v≤2, M is manganese, iron, nickel, cobalt, chromium, copper, titanium, zinc, vanadium, zirconium, cerium, or a combination thereof, and X and Z are each independently phosphorus, sulfur, silicon, or a combination thereof,
NaₓM1O₂ Formula 10
wherein in Formula 10, 0<x≤1, and M1 is titanium, vanadium, manganese, cobalt, nickel, iron, chromium, copper, or a combination thereof,
NaₐNi_{b}M2_{c}M3_{d}M4ₑM5_{f}O₂ Formula 11
wherein in Formula 11, 0.4≤a<1, 0<b<0.5, 0≤c<1, 0≤d<0.5, 0≤e<0.5, 0≤f<0.5, and 0<c+e, M2 is manganese, titanium, zirconium, or a combination thereof, M3 is magnesium, calcium, copper, zinc, cobalt, or a combination thereof, M4 is manganese, titanium, zirconium, or a combination thereof, and M5 is aluminum, iron, cobalt, molybdenum, chromium, vanadium, scandium, yttrium, or a combination thereof, or
NaₓM1_{y}M2_{z}(CN)₆ Formula 12
wherein in Formula 12, 0<x≤2, 0<y<1, and 0<z<1, and M1 and M2 are each independently manganese, nickel, copper, cobalt, iron, zinc, vanadium, chromium, or a combination thereof.

17. The sodium all-solid secondary battery of claim 10,
wherein the solid electrolyte further comprises a sulfide solid electrolyte, an oxide solid electrolyte, a polymer solid electrolyte, or a combination thereof, and the gel electrolyte comprises a polymer gel electrolyte.

18. The sodium all-solid secondary battery of claim 17,
wherein the sulfide solid electrolyte comprises Na₃PS₄, Na₃₋ₓPS₄₋ₓClₓ wherein 0<x<3, Na₃₋ₓP₁₋ₓWₓS₄ wherein 0≤x<1, Na₃PS₄₋ₓOₓ wherein 0<x<4, Na₃₋₂ₓCaₓPS₄ wherein 0<x<1.5, Na₃SbS₄, Na₃₋ₓSb₁₋ₓWₓS₄ wherein 0≤x<1, Na_{2.88}Sb_{0.88}W_{0.12}S₄₋ₓNal wherein 0<x<1, Na₃WₓSiₓSb₁₋₂ₓS₄ wherein 0≤x<0.5, Na₃₋ₓSb₁₋ₓWₓS₄₋₃ₓO₃ₓ wherein 0≤x<1, Na₃SbS₄—Na₂WₓS₄I₆ₓ₋₄ wherein 0≤x<1, Na₂S—P₂S₅, Na₂S—P₂S₅—NaX wherein X is F, Cl, Br, or I, Na₂S—P₂S₅—Na₂O, Na₂S—P₂S₅—Na₂O-Nal, Na₂S—SiS₂, Na₂S—SiS₂-Nal, Na₂S—SiS₂—NaBr, Na₂S—SiS₂—NaCl, Na₂S—SiS₂—B₂S₃-Nal, Na₂S—SiS₂—P₂S₅-Nal, Na₂S—B₂S₃, Na₂S—P₂S₅—ZₘSₙ, wherein 0<m≤10, 0<n<10, and Z is Ge, Zn, or Ga, Na₂S—GeS₂, Na₂S—SiS₂—Na₃PO₄, Na₂S—SiS₂-NaₚMO_{q} wherein 0<p≤10, 0<q≤10 and M is P, Si, Ge, B, Al, Ga, or In, Na₇₋ₓPS₆₋ₓClₓ wherein 0≤x≤2, Na₇₋ₓPS₆₋ₓBrₓ wherein 0≤x≤2, Na₇₋ₓPS₆₋ₓIₓ wherein 0≤x≤2, Na₁OMP₂S₁₂ wherein M is Ge, Si, or Sₙ, or a combination thereof, and
the sulfide solid electrolyte is crystalline, amorphous, or glass-ceramic.

19. The sodium all-solid secondary battery of claim 17,
wherein the oxide solid electrolyte comprises NaₐM1_{b}M2_{c}O_{d}, wherein M1 is Al, Y, Yb, Nd, Nb, Ti, or Hf, M2 is Si, or P, 1≤a≤6 1≤b≤3, 2≤c≤5, and 5≤d≤15, Na₁₊ₓZr₂SiₓP₃₋ₓO₁₂ wherein 0≤x≤3, NaₓM2(PO₄)₃ wherein M is V or Ti and 0≤x≤3, Na₃₊ₓLa_{(2/3-x)(1/3-2x)}TiO₃ wherein 0.04<x<0.16, Na₁₊ₓAlₓTi₂₋ₓ(PO₄)₃ wherein 0<x<2, Na₁₊ₓAlₓGe₂₋ₓ(PO₄)₃ wherein 0<x<2, Na_{1+x+y}AlₓTi₂₋ₓSi_{y}P_{3-y}O₁₂ wherein 0<x<2 and 0≤y<3, BaTiO₃, Pb(ZrₐTi₁₋ₐ)O₃ wherein 0≤a≤1, Pb₁₋ₓLaₓZr_{1-y}Ti_{y}O₃ wherein 0≤x<1 and 0≤y<1, Pb(Mg_{1/3}Nb_{2/3})O₃—P_{b}TiO₃, Na₃PO₄, NaₓTi_{y}(PO₄)₃ wherein 0<x<2 and 0<y<3, NaₓAl_{y}Ti_{z}(PO₄)₃ wherein 0<x<2, 0<y<1, and 0<z<3, Na_{1+x+y}(AlₐGa₁₋ₐ)ₓ(Ti_{b}Ge_{1-b})₂₋ₓSi_{y}P_{3-y}O₁₂ wherein 0≤x≤1, 0≤y≤1, 0≤a≤1, and 0≤b≤1, NaₓLa_{y}TiO₃ wherein 0<x<2 and 0<y<3, Na₂O, NaOH, Na₂CO₃, NaAlO₂, Na₂O—Al₂O₃—SiO₂—P₂O₅—TiO₂—GeO₂, Na₃₊ₓLa₃M₂O₁₂ wherein M is Te, Nb or Zr and 1≤x≤10, Na₇La₃Zr₂O₁₂, Na₃₊ₓLa₃Zr₂₋ₐMₐO₁₂ wherein M is Ga, W, Nb, Ta, or Al, 0<a<2, and 1≤x≤10, or a combination thereof, and
the oxide solid electrolyte is crystalline, amorphous, or glass-ceramic.

20. A method of manufacturing a sodium all-solid battery, the method comprising:
providing a cathode, an anode, and a solid electrolyte layer between the cathode and the anode,
wherein the cathode, the anode, the solid electrolyte layer, or a combination thereof comprise a sulfide solid electrolyte represented by Formula 1, and
the sulfide solid electrolyte is manufactured by combining a sodium precursor, a phosphorus precursor, a tungsten precursor, a M-containing precursor, and a sulfur precursor to provide a precursor mixture; and
treating the precursor mixture to provide the sulfide solid electrolyte, wherein the sulfide solid electrolyte is represented by Formula 1:
Na_{3±x}P_{1-(y1+y2)}W_{y1}M_{y2}S_{4-z}X_{z} Formula 1
wherein in Formula 1, M is a trivalent element, a tetravalent element, or a combination thereof, X is a halogen atom, or a combination thereof, 0≤x≤1, 0<y1≤0.5, 0≤z≤1, and 0≤y2≤0.5,
wherein if z=0, y2 is not 0.
